(19) United States
(12) Patent Application Publication
(10) Pub. No.: US 2016/0145486 A1
(43) Pub. Date: May 26, 2016

(54) WELLBORE SERVICING COMPOSITIONS AND METHODS OF MAKING AND USING SAME

(71) Applicant: HALLIBURTON ENERGY SERVICES, INC., Houston, TX (US)

(72) Inventors: Jim D. Weaver, Duncan, OK (US); Michael A. McCabe, Duncan, OK (US); Ronnie G. Morgan, Waurika, OK (US)

(73) Assignee: Halliburton Energy Services, Inc., Houston, TX (US)

(21) Appl. No.: 14/901,855

(22) PCT Filed: Jul. 31, 2013
(86) PCT No.: PCT/US2013/052917

§ 371 Date: Dec. 29, 2015

(51) Int. Cl. C09K 8/70

(52) U.S. Cl. CPC C09K 8/703

(57) ABSTRACT

A wellbore servicing foam comprising a reducible material and a wellbore servicing material, wherein the wellbore servicing material is uniformly dispersed throughout the foam, and wherein the foam has (i) equal to or greater than 5% reticulated structure and (ii) a specific surface area of from about 0.1 m²/g to about 1000 m²/g as determined by pycnometry. A highly expanded, wellbore servicing foam comprising a reducible material and a wellbore servicing material, wherein the wellbore servicing material is uniformly dispersed throughout the foam, wherein the foam has (i) a percentage expansion of from about 5% to about 6200% when compared to the same amount of the same reducible material in the absence of expansion, (ii) a specific surface area of from about 0.1 m²/g to about 1000 m²/g as determined by pycnometry, and (iii) equal to or greater than 5% reticulated structure.

### BACKGROUND

This disclosure relates to methods of servicing a wellbore. More specifically, it relates to methods of treating a wellbore with foam materials.

Natural resources (e.g., oil or gas) residing in a subterranean formation may be recovered by driving resources from the formation into a wellbore using, for example, a pressure gradient that exists between the formation and the wellbore, the force of gravity, displacement of the resources from the formation using a pump or the force of another fluid injected into the well or an adjacent well. The production of fluid in the formation may be increased by hydraulically fracturing the formation. That is, a viscous fracturing fluid may be pumped down the wellbore at a rate and a pressure sufficient to form fractures that extend into the formation, providing additional pathways through which the oil or gas can flow to the well.

To maintain the fractures open when the fracturing pressures are removed, a particulate material such as for example a propping agent (i.e., a proppant) may be used. Particulate packs (e.g., proppant packs) are typically introduced into the wellbore and surrounding formation during fracturing and completion operations in order to provide a structural frame for both downhole support and fluid collection, e.g., consolidate the wellbore and/or subterranean formation. The conductivity of the particulate pack (e.g., proppant pack) may be enhanced in some instances by promoting the formation of channels through the particulate pack (e.g., proppant pack), which may further lead to enhanced wellbore productivity. Thus, an ongoing need exists for more effective compositions and methods of promoting the formation of channels through particulate packs (e.g., proppant packs) in subterranean formations.

### SUMMARY

Disclosed herein is a wellbore servicing foam comprising a reducible material and a wellbore servicing material, wherein the wellbore servicing material is uniformly dispersed throughout the foam, and wherein the foam has (i) equal to or greater than 5% reticulated structure and (ii) a specific surface area of from about 0.1 m²/g to about 1000 m²/g as determined by pycnometry.

Also disclosed herein is a highly expanded, wellbore servicing foam comprising a reducible material and a wellbore servicing material, wherein the wellbore servicing material is uniformly dispersed throughout the foam, wherein the foam has (i) a percentage expansion of from about 5% to about 6200% when compared to the same amount of the same reducible material in the absence of expansion, (ii) a specific surface area of from about 0.1 m²/g to about 1000 m²/g as determined by pycnometry, and (iii) equal to or greater than 5% reticulated structure.

Further disclosed herein is a wellbore servicing fluid comprising (i) a wellbore servicing foam having equal to or greater than 5% reticulated structure and (ii) an aqueous base fluid.

Further disclosed herein is a method of servicing a wellbore in a subterranean formation comprising preparing a wellbore servicing fluid comprising a wellbore servicing foam having equal to or greater than 5% reticulated structure, a particulate material and an aqueous base fluid, placing the wellbore servicing fluid in the wellbore and/or subterranean formation, and allowing the reticulated material to degrade therein, wherein the degradation of the reticulated material yields a particulate material pack structure comprising a particulate material pack flow channel space.

Further disclosed herein is a method of servicing a wellbore in a subterranean formation comprising preparing a wellbore servicing fluid comprising a wellbore servicing foam having equal to or greater than 5% reticulated structure, and an aqueous base fluid, wherein the wellbore servicing foam comprises a breaker dispersed uniformly throughout the foam, placing the wellbore servicing fluid in the wellbore and/or subterranean formation and forming a filter cake on a surface of the wellbore and/or subterranean formation, wherein the filter cake comprises the wellbore servicing foam, allowing the wellbore servicing foam to degrade, wherein the degradation of the wellbore servicing foam provides for release of the breaker, and allowing the breaker to degrade the filter cake.

Further disclosed herein is a process for preparing a wellbore servicing foam comprising introducing a reducible material, a wellbore servicing material, and a foaming agent to an extruder, heating the reducible material and the wellbore servicing material to form a melt mixture, wherein the foaming agent introduces porosity into the melt mixture, and extruding the melt mixture through a die assembly to form the wellbore servicing foam.

Further disclosed herein is a process for preparing a wellbore servicing foam comprising introducing a reducible material to a twin-screw co-rotating intermeshing extruder, wherein co-rotating intermeshing screws convey the reducible material, heating the reducible material to form a melt mixture, wherein heat is generated by frictional dissipation or via direct convection/conduction heat being transferred from barrel jackets of the extruder, blending a wellbore servicing material in the melt mixture, introducing a foaming agent to the melt mixture, wherein the foaming agent introduces porosity into the melt mixture and wherein the foaming agent comprises carbon dioxide or nitrogen, extruding the melt mixture through a die assembly to form an extrudate wellbore servicing foam, wherein the die assembly comprises a die hole with a diameter of from about 2 microns to about 2000 microns and wherein the environment surrounding the die assembly is kept pressurized by water vapor, cutting the extrudate wellbore servicing foam into lengths that are from about 0.25 to about 5 times the diameter of the die hole, cooling the extrudate wellbore servicing foam,drying the extrudate wellbore servicing foam, and mechanically sizing the extrudate wellbore servicing foam into a plurality of wellbore servicing foam particles, wherein mechanically sizing comprises grinding.

Further disclosed herein is a process for preparing a wellbore servicing foam comprising introducing a reducible material to a twin-screw co-rotating intermeshing extruder, wherein co-rotating intermeshing screws convey the reducible material, heating the reducible material to form a melt mixture, wherein the heat is generated by frictional dissipation or via direct convection/conduction heat being transferred from barrel jackets of the extruder, blending a breaker and a wellbore servicing material in the melt mixture, introducing a foaming agent to the melt mixture, wherein the foaming agent introduces porosity into the melt mixture and wherein the foaming agent comprises carbon dioxide or nitrogen, extruding the melt mixture through a die assembly and into a pelleting mill to form an extrudate wellbore servicing foam, wherein the melt mixture is physically forced into the die assembly by a planetary system of rotating press wheels, wherein the die assembly comprises a die hole with a diameter of from about 2 microns to about 2000 microns and wherein the environment surrounding the die assembly is kept pressurized by water vapor, cooling the extrudate wellbore servicing foam, drying the extrudate wellbore servicing foam, and mechanically sizing the extrudate wellbore servicing foam into a plurality of wellbore servicing foam particles, wherein mechanically sizing comprises grinding.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1A and 1B display images of reticulated foam structures.

FIG. 2 is a schematic representation of a particulate material pack (FIG. 2A) before and (FIG. 2B) after degradation of a wellbore servicing foam.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

Disclosed herein are wellbore servicing fluids or compositions (collectively referred to herein as WSFs) and methods of using same. In an embodiment, the wellbore servicing fluid may comprise a wellbore servicing foam and a sufficient amount of an aqueous base fluid to form a pumpable WSF, wherein the foam comprises equal to or greater than 5% reticulated structure. In an embodiment, the wellbore servicing foam comprises a reducible material and a wellbore servicing material, wherein the wellbore servicing material is uniformly dispersed throughout the foam, and wherein the foam comprises equal to or greater than 5% reticulated structure. In an embodiment, utilization of a WSF comprising a wellbore servicing foam in the methods disclosed herein may advantageously facilitate the consolidation and/or enhancing the conductivity of at least a portion of the wellbore and/or subterranean formation. In another embodiment, utilization of a WSF comprising a wellbore servicing foam in the methods disclosed herein may advantageously facilitate the removal of at least a portion of a filter cake in a wellbore and/or subterranean formation.

In an embodiment, the wellbore servicing foam comprises a wellbore servicing material uniformly dispersed throughout the foam, e.g., a wellbore servicing material uniformly dispersed throughout the reducible material, wherein the foam comprises equal to or greater than 5% reticulated structure. In such embodiment, the wellbore servicing foam is intended to carry the wellbore servicing material for a specific time period. In such embodiment, the wellbore servicing foam is effective as a carrier and the wellbore servicing material carried by the wellbore servicing foam is effective as a cargo. In an embodiment, the carrier (i.e., the wellbore servicing foam) is capable of engulfing, embedding, confining, surrounding, encompassing, enveloping, or otherwise retaining the cargo (e.g., wellbore servicing material) such that the carrier and cargo are transported downhole as a single material. In an embodiment, the cargo comprises a wellbore servicing material that is carried or otherwise transported by the carrier wellbore servicing foam. Further it is to be understood that the carrier wellbore servicing foam confines the cargo (e.g., wellbore servicing material) to the extent necessary to facilitate the about concurrent transport of both materials (e.g., reducible material and wellbore servicing material). In an embodiment, the cargo replaces some portion of the material (e.g., reducible material) typically found within the carrier.

In an embodiment, the wellbore servicing foam comprises a reticulated or highly expanded foam. As used herein, the terms reticulated, highly expanded, wellbore servicing foam; reticulated, wellbore servicing foam; reticulated foam; reticulated material; and the like refer to a foamed material (which sometimes may be referred to as a base material, a matrix material, a solid material, or the like) having a reticulated structure, also referred to as a reticulated structural matrix. In an embodiment, the foamed material is a reducible material having one or more wellbore servicing materials uniformly dispersed throughout. In an embodiment, the reticulated foam has equal to or greater than 5, 10, 15, 20, 25, 30, 35, 40, 45, 50, 55, 60, 65, 70, 75, 80, 85, 90, 91, 92, 93, 94, 95, 96, 97, 98, or 99% reticulated structure as determined by dual beam focused ion beam/scanning electron microscopy (FIB/SEM) and image analysis. In an embodiment, the reticulated foam has a predominately reticulated structure. In an embodiment, the reticulated foam has a completely reticulated structure (e.g., about equal to 100%).

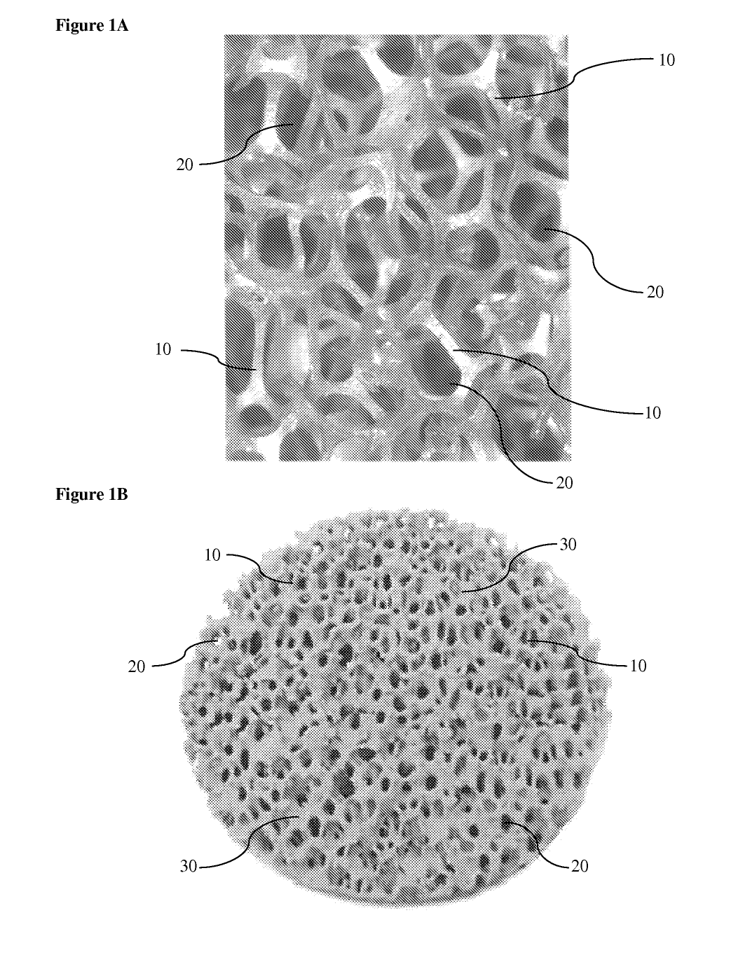

In some embodiments, the reticulated structure may resemble an open-cell structure, for example resembling a three dimensional net or matrix. As seen in FIGS. 1A and 1B, the open-cell structure may be represented by the lineal boundary 10 material (e.g., the edges or struts or ligaments) remaining from bubbles formed during the foaming process. In other words, the area and material where bubbles or cells contacted one another (for example, bubbles or cells having a wide variety of irregular shapes such as polyhedra contact one another along various lineal boundaries or edges 10) remain in the open-cell structure while bubble/cell wall or face material is absent leaving a very open, porous net-like structure (e.g., leaving pores or pore spaces 20). In a reticulated structure, few, if any, intact bubbles or cell windows 30 remain. In an embodiment, the reticulated foam has equal to or greater than 5, 10, 15, 20, 25, 30, 35, 40, 45, 50, 55, 60, 65, 70, 75, 80, 85, 90, 91, 92, 93, 94, 95, 96, 97, 98, or 99% open-cell structure as determined by FIB/SEM and image analysis. In an embodiment, the reticulated foam has a predominately open-cell structure (e.g., as seen in FIG. 1B). In an embodiment, the reticulated foam has a completely open-cell structure (e.g., about equal to 100%), e.g., as seen in FIG. 1A.

In an embodiment, the wellbore servicing foam comprises a highly expanded, wellbore servicing foam, wherein the foam may be characterized by a percentage expansion of from about 5% to about 6200%, alternatively from about 10% to about 500%, or alternatively from about 30% to about 200%, when compared to the same amount of the same material in the absence of expansion.

In an embodiment, the wellbore servicing foam may be characterized by a porosity of from about 10 vol. % to about 99 vol. %, alternatively from about 51 vol. % to about 99 vol. %, or alternatively from about 90 vol. % to about 98 vol. %, based on the total volume of the wellbore servicing foam, wherein the porosity may be determined by a density ratio determined by specific gravity of a wellbore servicing foam material prior to foaming and pycnometry porosimetry. Generally, the porosity of a material is defined as the percentage of volume that the pores (i.e., voids, empty spaces) occupy based on the total volume of the material. The porosity of the wellbore servicing foam may be determined using a porosity tester such as the Foam Porosity Tester F0023 which is commercially available from IDM Instruments. The reticulated structure is highly porous, and in some embodiments the porosity may be equal to or greater than 90, 95, 96, 97, or 98 vol. %, based on the total volume of the wellbore servicing foam.

In an embodiment, the wellbore servicing foam comprising a reticulated structure may be characterized by a pore size of from about 0.1 microns to about 3000 microns, alternatively from about 10 microns to about 500 microns, or alternatively from about 1 micron to about 150 microns, as determined by FIB/SEM and image analysis.

In an embodiment, the wellbore servicing foam comprising a reticulated structure may be characterized by a specific surface area of from about 0.1 m²/g to about 1000 m²/g, alternatively from about 1 m²/g to about 500 m²/g, or from about 10 m²/g to about 200 m²/g, as determined by pycnometry.

In an embodiment, the wellbore servicing foam comprises a granular material, which may be characterized by a particle size of from about 10 microns to about 12000 microns, alternatively from about 20 microns to about 5000 microns, or alternatively from about 50 microns to about 1000 microns.

In an embodiment, the reducible material of the wellbore servicing foam may undergo a size and/or weight reduction or degradation process as will be described later herein. In an embodiment, the wellbore servicing foam comprising a reticulated structure may be characterized by a degradation rate (e.g., rate of degradation by weight of the wellbore servicing foam) that is from about 100% per hour to about 100% per year greater, alternatively from about 50% per hour to about 100% per month greater, or from about 50% per hour to about 100% per week greater than the degradation rate for the same amount of the same material in the absence of reticulation. For example, if a g of a reticulated material degrades completely in 1 year, and 0.5a g of the same material prior to reticulation degrades completely in 1 year, the degradation rate of the reticulated material is about 100% per year greater than the degradation rate for the same amount of the same material in the absence of reticulation. Similarly, for example, if 1.5b g of a reticulated material degrades completely in 1 hour, and b g of the same material prior to reticulation degrades completely in 1 hour, the degradation rate of the reticulated material is about 50% per hour greater than the degradation rate for the same amount of the same material in the absence of reticulation. Without wishing to be limited by theory, the degradation rate (e.g., rate of degradation by weight) and/or the rate of size reduction of a material (e.g., wellbore servicing foam) correlates with the specific surface area of such material (e.g., wellbore servicing foam), i.e., the greater the specific surface area, the greater the degradation rate.

In an embodiment, the wellbore servicing foam may be configured such that the density of the wellbore servicing foam is about equal to the density of the WSF, e.g., such that the wellbore servicing foam has neutral buoyancy with respect to the WSF. As used herein, an object (e.g., wellbore servicing foam) immersed in a fluid (e.g., WSF) wherein the density of the object (e.g., wellbore servicing foam) is equal to the density of the fluid (ρ_{object}=ρ_{fluid}) shall be referred to as having “neutral buoyancy.” As used herein, an object (e.g., wellbore servicing foam) immersed in a fluid wherein the density of the object (e.g., wellbore servicing foam) is less than the density of the surrounding fluid (ρ_{object}<ρ_{fluid}) shall be referred to as having “positive buoyancy,” e.g., the object (e.g., wellbore servicing foam) floats. As used herein, an object (e.g., wellbore servicing foam) immersed in a fluid wherein the density of the object (e.g., wellbore servicing foam) is greater than the density of the surrounding fluid (ρ_{object}>ρ_{fluid}) shall be referred to as having “negative buoyancy,” e.g., the object (e.g., wellbore servicing foam) sinks or settles in the fluid.

In an embodiment, the wellbore servicing foam may be configured to maintain neutral buoyancy in aqueous wellbore fluids (e.g., WSF) under typical downhole conditions. In an embodiment, the wellbore servicing foam may be configured to maintain neutral buoyancy in a particular wellbore environment (e.g., at ambient wellbore temperature, pressure, wellbore fluid composition, well depth and associated hydrostatic fluid pressure, etc.). In an embodiment, the wellbore servicing foam may be configured to maintain a neutral buoyancy by adjusting the amount of a wellbore servicing material in the wellbore servicing foam, by adjusting the properties of the wellbore servicing foam (e.g., porosity, percentage expansion, etc.), or a combination thereof. In some embodiments, the wellbore servicing foam may be configured to transition from neutral buoyancy to negative buoyancy when the wellbore environment conditions change (e.g. temperature, pressure, pH, etc.).

In an embodiment, the wellbore servicing foam may be included within the WSF in a suitable amount. In an embodiment, the wellbore servicing foam is present within the WSF in an amount of from about 0.1 vol. % to about 12 vol. %, alternatively from about 0.5 vol. % to about 7 vol. %, or alternatively from about 1 vol. % to about 5 vol. %, based on the total volume of the WSF.

In an embodiment, the WSF comprises a wellbore servicing foam and a particulate material. In such embodiment, the wellbore servicing foam is present within the WSF in an amount of from about 0.01 wt. % to about 100 wt. %, alternatively from about 0.1wt. % to about 50 wt. %, or alternatively from about 0.5 wt. % to about 20 wt. %, based on the total weight of the particulate material.

In an embodiment, the wellbore servicing foam comprises a reducible material. As used herein, a “reducible material” refers to any material that facilitates size and/or weight reduction of the wellbore servicing foam under conditions that may be naturally encountered and/or artificially created in a wellbore environment.

In an embodiment, the reducible material may be comprised of a naturally-occurring material. Alternatively, the reducible material comprises a synthetic material. Alternatively, the reducible material comprises a mixture of a naturally-occurring and synthetic material.

In various embodiments, the reducible material may comprise a frangible material, an erodible material, a dissolvable material, a consumable material, a thermally degradable material, a meltable material, a boilable material, a degradable material (including biodegradable materials), an ablatable material, or combinations thereof. Designation of a particular reducible material as dissolvable, meltable, etc., is non-limiting and non-exclusive, and the same material may have more than one designation (e.g., various materials may overlap designations). In one embodiment, the reducible material may be effective to increase the rate of such a size and/or weight reduction after the reducible material experiences a phase change.

By incorporating one or more reducible materials into a wellbore servicing foam, the probability of recovering, relocating, and/or consuming the wellbore servicing foam may be improved. For example, when a wellbore servicing foam comprising a dissolvable reducible material is trapped or stuck in a particular portion of the wellbore and/or subterranean formation, dissolution of some of the dissolvable material may allow the wellbore servicing foam to be reduced in size and/or weight (e.g., by portions of the wellbore servicing foam breaking off and/or dissolving) sufficient for the wellbore servicing foam to break free. In instances where recovery of the wellbore servicing foam cannot be achieved and/or is undesirable, deterioration of one or more reducible materials present in the wellbore servicing foam may reduce or eliminate the wellbore servicing foam as an impediment to wellbore operations by reducing the size and/or weight of the wellbore servicing foam enough to liberate and relocate the wellbore servicing foam. Additionally or alternatively, the wellbore servicing foam may be deteriorated and/or consumed as a consequence of the deterioration of one or more reducible materials therein to a degree (e.g., >50, 60, 70, 80, 90, 95, 99, % by weight and/or completely deteriorated) such that no structural impediment exists to continued wellbore servicing operations.

In various embodiments, a wellbore servicing foam comprises two or more different reducible materials (e.g., two different dissolvable materials; a dissolvable material and a biodegradable material, etc.). By including multiple distinct reducible materials, the recovery, relocation, and/or consumption of the wellbore servicing foam may be further improved by expanding the options available to an operator to reduce the size and/or weight of the wellbore servicing foam. In instances where the necessary wellbore conditions are not available to enable size and/or weight reduction of a wellbore servicing foam via the size-reduction and/or weight-reduction mechanism of one reducible material, size and/or weight reduction may still be achieved if conditions are sufficient to enable the size-reduction and/or weight-reduction mechanism of another reducible material present in the wellbore servicing foam.

In various embodiments, the reducible material may comprise any suitable material. Nonlimiting examples of reducible materials suitable for use in the present disclosure include resins, epoxies, rubbers, hardened plastics, phenolic materials, polymeric materials, degradable polymers, composite materials, metallic materials, metals and metal alloys, cast materials, ceramic materials, ceramic based resins, composite materials, resin composite materials, or combinations thereof. Herein the disclosure may refer to a polymer and/or a polymeric material. It is to be understood that the terms polymer and/or polymeric material herein are used interchangeably and are meant to each refer to compositions comprising at least one polymerized monomer in the presence or absence of other additives traditionally included in such materials. Examples of polymeric materials suitable for use as part of the reducible material include, but are not limited to homopolymers, random, block, graft, star- and hyper-branched polyesters, copolymers thereof, derivatives thereof, or combinations thereof. The term “derivative” herein is defined to include any compound that is made from one or more of the reducible materials, for example, by replacing one atom in the reducible material with another atom or group of atoms, rearranging two or more atoms in the reducible material, ionizing one of the reducible materials, or creating a salt of one of the reducible materials. The term “copolymer” as used herein is not limited to the combination of two polymers, but includes any combination of any number of polymers, e.g., graft polymers, terpolymers, and the like.

In an embodiment, the reducible material may comprise a polymeric material, such as for example a resin material. Nonlimiting examples of resin materials suitable for use in the present disclosure include thermosetting resins, thermoplastic resins, solid polymer plastics, and combinations thereof. Suitable thermosetting resins may include, but are not limited to, thermosetting epoxies, bismaleimides, cyanates, unsaturated polyesters, noncellular polyurethanes, orthophthalic polyesters, isophthalic polyesters, phthalic/maleic type polyesters, vinyl esters, phenolics, polyimides, including nadic-end-capped polyimides (e.g., PMR-15), and any combinations thereof. Suitable thermoplastic resins may include, but are not limited to, polyether ether ketones, polyaryletherketones, polysulfones, polyamides, polycarbonates, polyphenylene oxides, polysulfides, including polyphenylenesulfide (PPS), polyether sulfones, polyamide-imides, polyetherimides, polyimides, polyarylates, poly(lactide), poly(glycolide), liquid crystalline polyester, aromatic and aliphatic nylons, and any combinations thereof.

In an embodiment, the reducible material may comprise a two-component resin composition. Suitable two-component resin materials may include a hardenable resin and a hardening agent that, when combined, react to form a cured resin reducible material. Suitable hardenable resins that may be used include, but are not limited to, organic resins such as bisphenol A diglycidyl ether resins, butoxymethyl butyl glycidyl ether resins, bisphenol A-epichlorohydrin resins, bisphenol F resins, polyepoxide resins, novolak resins, polyester resins, phenol-aldehyde resins, urea-aldehyde resins, furan resins, urethane resins, glycidyl ether resins, other epoxide resins, and any combinations thereof. Suitable hardening agents that can be used include, but are not limited to, cyclo-aliphatic amines; aromatic amines; aliphatic amines; imidazole; pyrazole; pyrazine; pyrimidine; pyridazine; 1H-indazole; purine; phthalazine; naphthyridine; quinoxaline; quinazoline; phenazine; imidazolidine; cinnoline; imidazoline; 1,3,5-triazine; thiazole; pteridine; indazole; amines; polyamines; amides; polyamides; 2-ethyl-4-methyl imidazole; and any combinations thereof. In an embodiment, one or more additional components may be added to the resin material to affect the properties of the reducible material.

In various embodiments, the reducible material comprises one or more metals. Metals suitable for use as matrix materials may be any suitable metal, alloy, or intermetallic. Exemplary embodiments of metal reducible materials include, but are not limited to, aluminum, magnesium, nickel, aluminum alloy, magnesium alloy, titanium alloy, nickel alloy, steel, titanium aluminide, nickel aluminide, and the like, or combinations thereof. In an embodiment, the reducible material of the wellbore servicing foam comprises aluminum, an aluminum alloy, or a combination thereof. In another embodiment, the reducible material of the wellbore servicing foam comprises magnesium, a magnesium alloy, or a combination thereof. Examples of suitable aluminum alloy and magnesium alloy reducible materials include, but are not limited to, AlCu4 alloy, AlSil2 alloy, AlSi7 alloy, AlMg4 alloy and AlMg SiCu alloy. Another non-limiting example of a suitable aluminum alloy includes RR58. Another non-limiting example of a suitable magnesium alloy suitable for use as a metal reducible material includes RZ5. In an embodiment, the reducible material of the wellbore servicing foam comprises titanium, a titanium alloy, or a combination thereof. Examples of titanium alloys suitable for use as metal matrix materials include, but are not limited to, Ti64 alloy, Ti6242 alloy, Ti6246 alloy and Ti679 alloy. In an embodiment, the reducible material of the wellbore servicing foam comprises steel, a steel alloy, or a combination thereof. An exemplary embodiment of a steel suitable for use as a metal reducible material includes Jethete. In an embodiment, the reducible material of the wellbore servicing foam comprises nickel, a nickel alloy, or a combination thereof. An exemplary embodiment of a nickel alloy suitable for use as a metal reducible material includes Inco 718.

In various embodiments, the reducible material may be formed from one or more composite materials. For example, in various embodiments the reducible material may comprise a composite resin material. In various embodiments, the composite resin material may comprise an epoxy resin. In further embodiments, the composite resin material may comprise at least one ceramic material. For example, the composite material may comprise a ceramic based resin including, but not limited to, the types disclosed in U.S. Patent Application Publication Nos. US 2005/0224123 A1, entitled “Integral Centraliser” and published on Oct. 13, 2005, and US 2007/0131414 A1, entitled “Method for Making Centralizers for Centralising a Tight Fitting Casing in a Borehole” and published on Jun. 14, 2007. For example, in some embodiments, the resin material may include bonding agents such as an adhesive or other curable components. In some embodiments, components to be mixed with the resin material may include a hardener, an accelerator, or a curing initiator. Further, in some embodiments, a ceramic based resin composite material may comprise a catalyst to initiate curing of the ceramic based resin composite material. The catalyst may be thermally activated. Alternatively, the mixed materials of the composite material may be chemically activated by a curing initiator. More specifically, in some embodiments, the composite material may comprise a curable resin and ceramic particulate filler materials, optionally including chopped carbon fiber materials. In some embodiments, a compound of resins may be characterized by a high mechanical resistance, a high degree of surface adhesion and resistance to abrasion by friction.

In various embodiments, the reducible material may comprise a dissolvable material (e.g., dissolvable reducible material). The dissolvable material may comprise an oil-soluble material, a water-soluble material, an acid-soluble material, or a combination thereof. As used herein, the term “oil-soluble” refers to a material capable of dissolving when exposed to an oleaginous fluid (e.g., oil) under downhole conditions. Suitable oil-soluble materials include, but are not limited to, oil-soluble polymers, oil-soluble resins, oil-soluble elastomers, oil-soluble rubbers, (e.g., latex), polyethylenes, polypropylenes, polystyrenes, carbonic acids, amines, waxes, copolymers thereof, derivatives thereof, or combinations thereof. As used herein, the term “water-soluble” refers to a material capable of dissolving when exposed to an aqueous wellbore fluid under downhole conditions. Suitable water-soluble materials include, but are not limited to, water-soluble polymers, water-soluble elastomers, carbonic acids, salts, amines, and inorganic salts. As used herein, the term “acid-soluble” refers to a material capable of dissolving when exposed to an acidic wellbore fluid (e.g., an acidizing fluid, aqueous acid solution, etc.) under downhole conditions. The presence of one or more reducible materials in the wellbore servicing foam may facilitate removal of the wellbore servicing foam from a particular portion of the wellbore and/or subterranean formation, and thereby facilitate the consolidation and/or enhancing the conductivity of at least a portion of the wellbore and/or subterranean formation.

In various embodiments, the reducible material may comprise a meltable material (e.g., meltable reducible material). As used herein, a “meltable material” refers to a material that melts under one or more downhole conditions. Examples of meltable materials that can be melted at downhole conditions include, but are not limited to, hydrocarbons having greater than or equal to about 30 carbon atoms; polycaprolactones; paraffins and waxes; carboxylic acids, such as benzoic acid, and carboxylic acid derivatives.

In some embodiments, the meltable material comprises an eutectic material (e.g., eutectic alloy). The eutectic alloy remains in a solid state at ambient surface temperatures. Eutectic materials (e.g., eutectic alloys) are characterized by forming very regular crystalline molecular lattices in the solid phase. Eutectic materials (e.g., eutectic alloys) are chemical compounds that have the physical characteristic of changing phase (melting or solidifying) at varying temperatures: melting at one temperature and solidifying at another. The temperature range between which the melting or solidification occurs is dependent on the composition of the eutectic material. When two or more of these materials are combined, the eutectic melting point is lower than the melting temperature of any of the composite compounds. The composite material may be approximately twice as dense as water, weighing approximately 120 pounds per cubic foot. In an embodiment, the eutectic material comprises a salt-based eutectic material, a metal-based eutectic material, or a combination thereof. Salt-based eutectic materials can be formulated to function at temperatures as low as about 30° F., and as high as about 1100° F. Metal-based eutectic materials can operate at temperatures exceeding about 1900° F. Nonlimiting examples suitable for use as eutectic materials (e.g., eutectic metal alloys or eutectic metallic alloys), include alloys of tin, bismuth, indium, lead, cadmium, or combinations thereof.

When a solid eutectic material is heated to the fusion (melting) point, it changes phase to a liquid state. As the eutectic material melts, it absorbs latent heat. When the temperature of the eutectic liquid solution phase is lowered to below the melting point, it does not solidify, but becomes a “super-cooled” liquid. The temperature must be lowered to the eutectic point (e.g., eutectic temperature) before it will change phase back to a solid. When the temperature is lowered to the eutectic point (e.g., eutectic temperature), the liquid-to-solid phase change occurs almost instantaneously, and forms a homogenous crystalline solid with significant mechanical strength.

The phase change from liquid to solid can also be triggered by inducing the initiation of the crystalline process. This may be accomplished by introducing free electrons into the liquid by various means, such as for example, by deformation of a piece of an electrically conductive metal.

Phase-changing salts are extremely stable. If they are not heated above their maximum operating temperature range, it is believed that they may operate indefinitely. At least some eutectic salts are environmentally safe, non-corrosive, and water-soluble. Moreover, as the working-temperature range of the eutectic salt may increase, the strength of the crystal lattice may increase and the physical hardness of the solid phase may increase as well.

Eutectic materials suitable for use in the wellbore servicing foams described herein include, but are not limited to, eutectic materials capable of melting at temperatures and pressures that may be encountered in the wellbore environment. A suitable eutectic material (e.g., eutectic salt) would be, for example, a eutectic salt that melts above about 200° C. and solidifies at about 160° C. Examples of eutectic material (e.g., eutectic salt) compositions suitable for use in the wellbore servicing foams disclosed herein include, but are not limited to, mixtures of NaCl, KCl, CaCl₂, KNO₃ and NaNO₃. In a nonlimiting exemplary embodiment, a wellbore servicing foam comprises a high temperature draw salt such as 430 PARKETTES (Heatbath Corporation). An additive such as a microglass bead or a glass fiber may be used to act as a reinforcement to increase the mechanical strength of the eutectic salt.

In various embodiments, the reducible material may comprise a consumable material (e.g., consumable reducible material) that is at least partially consumed when exposed to heat and a source of oxygen. If the consumable reducible material is burned and/or consumed due to exposure to heat and oxygen, the wellbore servicing foam comprising the consumable reducible material may lose structural integrity and crumble under the application of a relatively small external load and/or internal stress. In an embodiment, such load may be applied to the wellbore and controlled in such a manner so as to cause structural failure of the wellbore servicing foam.

The consumable reducible material may comprise a metal material, a thermoplastic material (e.g., consumable thermoplastic material), a phenolic material, a composite material, or combinations thereof. The consumable thermoplastic material may comprise polyalphaolefins, polyaryletherketones, polybutenes, nylons or polyamides, polycarbonates, thermoplastic polyesters, styrenic copolymers, thermoplastic elastomers, aromatic polyamides, cellulosic materials, ethylene vinyl acetate, fluoroplastics, polyacetals, polyethylenes, polypropylenes, polymethylpentene, polyphenylene oxide, polystyrene, polytetrafluoroethylene (e.g., TEFLON by DuPont), or combinations thereof. In an embodiment, the consumable reducible material comprises magnesium, which is converted to magnesium oxide when exposed to heat and a source of oxygen, as illustrated by the chemical reaction (1) below:

3Mg+Al₂O₃→3MgO+2Al (1)

In various embodiments, a wellbore servicing foam comprising a consumable reducible material may further comprise a fuel load. The fuel load may be formed from materials that, when ignited and burned, produce heat and an oxygen source, which in turn may act as the catalysts for initiating burning of consumable components of the wellbore servicing foam. The fuel load may comprise a flammable, non-explosive solid. A non-limiting example of a suitable fuel load is thermite. In one embodiment, a composition of thermite comprises iron oxide, or rust (Fe₂O₃), and aluminum metal power (Al). When ignited and burned, thermite reacts to produce aluminum oxide (Al₂O₃) and liquid iron (Fe), which is a molten plasma-like substance. The chemical reaction (2) is illustrated below:

Fe₂O₃+2Al₍ₛ₎→Al₂O₃₍ₛ₎+2Fe (2)

The wellbore servicing foam comprising a consumable material may also be used in conjunction with a firing mechanism, such as an electronic igniter, with a heat source to ignite the fuel load and a device to activate the heat source. In an embodiment, the wellbore servicing foam comprises a consumable material (e.g., magnesium) and a fuel source configured to initiate burning of the magnesium. In such embodiment, an igniter may be configured to ignite the fuel source. In an embodiment, the wellbore servicing foam comprises magnesium and a thermite fuel source configured to initiate burning of the magnesium. In such embodiment, an electronic igniter may be configured to ignite the thermite fuel source. Upon ignition of the fuel source by the electronic igniter, the thermite forms a high-temperature plasma which causes the magnesium to react with oxygen and form a magnesium oxide slag.

In various embodiments, the reducible material may comprise a degradable material (e.g., degradable reducible material). As used herein, the term “degradable materials” refers to materials that readily and irreversibly undergo a significant change in chemical structure under specific environmental conditions that result in the loss of some properties. For example, the degradable material may undergo hydrolytic degradation that ranges from the relatively extreme cases of heterogeneous (or bulk erosion) to homogeneous (or surface erosion), and any stage of degradation in between. In some embodiments, the degradable materials are degraded under defined conditions (e.g., as a function of time, exposure to chemical agents, etc.) to such an extent that the degradable materials are structurally compromised. In an alternative embodiment, the degradable materials can be degraded under defined conditions to such an extent that the degradable material no longer maintains its original form and is transformed from a degradable material having defined structural features to a plurality of masses lacking such structural features.

In an embodiment, the degradable material may be further characterized by possessing physical and/or mechanical properties that are compatible with its intended use in a wellbore servicing operation. In choosing the appropriate degradable material, one may consider the degradation products that will result. Also, one may select a degradable material having degradation products that do not adversely affect other wellbore servicing operations or any components thereof. One of ordinary skill in the art, with the benefit of this disclosure, will be able to recognize which degradable materials would produce degradation products that would adversely affect other wellbore servicing operations or any components thereof.

In some embodiments, the degradable reducible material comprises a degradable polymer. The degradability of a polymer depends at least in part on its backbone structure. For instance, the presence of hydrolyzable and/or oxidizable linkages in the backbone often yields a material that will degrade as described herein. The rates at which such polymers degrade are dependent on the type of repetitive unit, composition, sequence, length, molecular geometry, molecular weight, morphology (e.g., crystallinity, size of spherulites, and orientation), hydrophilicity, hydrophobicity, surface area, and additives. The degradable polymer may be chemically modified (e.g., chemical functionalization) in order to adjust the rate at which these materials degrade. Such adjustments may be made by one of ordinary skill in the art with the benefits of this disclosure. Further, the environment to which the polymer is subjected may affect how it degrades, e.g., temperature, presence of moisture, oxygen, microorganisms, enzymes, pH, and the like.

Examples of degradable polymers suitable for use in this disclosure include, but are not limited to, homopolymers, random, block, graft, and star- and hyper-branched aliphatic polyesters. In an embodiment, the degradable polymer comprises polysaccharides; lignosulfonates; chitins; chitosans; proteins; proteinous materials; fatty alcohols; fatty esters; fatty acid salts; orthoesters; aliphatic polyesters; poly(lactides); poly(glycolides); poly(ε-caprolactones); polyoxymethylene; polyurethanes; poly(hydroxybutyrate); poly(anhydrides); aliphatic polycarbonates; polyvinyl polymers; acrylic-based polymers; poly(amino acids); poly(aspartic acid); poly(alkylene oxides); poly(ethylene oxides); polyphosphazenes; poly(orthoesters); poly(hydroxy ester ethers); polyether esters; polyester amides; polyamides; polyhdroxyalkanoates; polyethyleneterephthalates; polybutyleneterephthalates; polyethylenenaphthalenates; and copolymers, blends, derivatives, or combinations thereof. Such degradable polymers may be prepared by polycondensation reactions, ring-opening polymerizations, free radical polymerizations, anionic polymerizations, carbocationic polymerizations, and coordinative ring-opening polymerization for, e.g., lactones, and any other suitable process. In an embodiment, the degradable material comprises BIOFOAM. BIOFOAM is a biodegradable plant-based foam commercially available from Synbra.

In some embodiments, one or more reducible materials are also comprised of a biodegradable material. As used herein, “biodegradable materials” refer to materials comprised of organic components that degrade over a relatively short period of time. Typically such materials are obtained from renewable raw materials. In some embodiments, the reducible material comprises a biodegradable polymer comprising aliphatic polyesters, polyanhydrides, or combinations thereof.

In some embodiments, one or more reducible materials are also comprised of a biodegradable polymer comprising an aliphatic polyester. Aliphatic polyesters degrade chemically, inter alia, by hydrolytic cleavage. Hydrolysis can be catalyzed by either acids or bases. Generally, during the hydrolysis, carboxylic end groups are formed during chain scission, and this may enhance the rate of further hydrolysis. This mechanism is known in the art as “autocatalysis,” and is thought to make polyester matrices more bulk eroding.

In an embodiment, the degradable polymer comprises solid cyclic dimers, or solid polymers of organic acids. Alternatively, the degradable polymer comprises substituted or unsubstituted lactides, glycolides, polylactic acid (PLA), polyglycolic acid (PGA), copolymers of PLA and PGA, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, or combinations thereof.

In an embodiment, the degradable polymer comprises an aliphatic polyester which may be represented by the general formula of repeating units shown in Formula I:

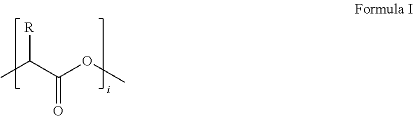

where i is an integer between 75 and 10,000 and R is selected from the group consisting of hydrogen, alkyl, aryl, alkylaryl, acetyl, heteroatoms, and mixtures thereof. In some embodiments, the aliphatic polyester is poly(lactide). Poly(lactide) is synthesized either from lactic acid by a condensation reaction or more commonly by ring-opening polymerization of cyclic lactide monomer. Since both lactic acid and lactide can achieve the same repeating unit, the general term poly(lactic acid) as used herein refers to Formula I without any limitation as to how the polymer was made such as from lactides, lactic acid, or oligomers, and without reference to the degree of polymerization or level of plasticization.

The lactide monomer exists generally in three different forms: two stereoisomers L- and D-lactide and racemic D,L-lactide (meso-lactide). The oligomers of lactic acid, and oligomers of lactide suitable for use in the present disclosure may be represented by general Formula II:

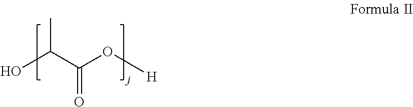

where j is an integer 2 <j≦75, alternatively, j is an integer and 2≦j≦10.

In some embodiments, the aliphatic polyester comprises poly(lactic acid). D-lactide is a dilactone, or cyclic dimer, of D-lactic acid. Similarly, L-lactide is a cyclic dimer of L-lactic acid. Meso D,L-lactide is a cyclic dimer of D-, and L-lactic acid. Racemic D,L-lactide comprises a 50/50 mixture of D-, and L-lactide. When used alone herein, the term “D,L-lactide” is intended to include meso D,L-lactide or racemic D,L-lactide. Poly(lactic acid) may be prepared from one or more of the above. The chirality of the lactide units provides a means to adjust degradation rates as well as physical and mechanical properties. Poly(L-lactide), for instance, is a semicrystalline polymer with a relatively slow hydrolysis rate. This may be advantageous for downhole operations where slow degradation may be appropriate. Poly(D,L-lactide) is an amorphous polymer with a faster hydrolysis rate. This may be advantageous for downhole operations where a more rapid degradation may be appropriate.

The stereoisomers of lactic acid may be used individually or combined in accordance with the present disclosure. Additionally, they may be copolymerized with, for example, glycolide or other monomers like c-caprolactone, 1,5-dioxepan-2-one, trimethylene carbonate, or other suitable monomers to obtain polymers with different properties or degradation times. Additionally, the lactic acid stereoisomers can be modified by blending, copolymerizing or otherwise mixing high and low molecular weight polylactides; or by blending, copolymerizing or otherwise mixing a polylactide with another polyester or polyesters.

The aliphatic polyesters may be prepared by substantially any of the conventionally known manufacturing methods such as those described in U.S. Pat. Nos. 6,323,307; 5,216,050; 4,387,769; 3,912,692; and 2,703,316, the relevant disclosure of which are incorporated herein by reference.

In some embodiments, the biodegradable polymer comprises a plasticizer. Suitable plasticizers include but are not limited to derivatives of oligomeric lactic acid, selected from the group defined by Formula III:

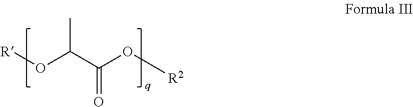

where R² is a hydrogen, alkyl, aryl, alkylaryl, acetyl, heteroatom, or a mixture thereof and R² is saturated, where R′ is a hydrogen, alkyl, aryl, alkylaryl, acetyl, heteroatom, or a mixture thereof and R′ is saturated, where R² and R′ cannot both be hydrogen, where q is an integer 2≦q≦75, alternatively, q is an integer and 2≦q≦10; and mixtures thereof. As used herein the term “derivatives of oligomeric lactic acid” includes derivatives of oligomeric lactide.

The plasticizers may be present in any amount that provides the desired characteristics. For example, the various types of plasticizers discussed herein provide for (a) more effective compatibilization of the melt blend components used in forming a wellbore servicing foam; (b) improved processing characteristics during the blending and processing steps in forming a wellbore servicing foam; and (c) control and regulate the sensitivity and degradation of the polymer by moisture when forming a wellbore servicing foam. For pliability, plasticizer is present in higher amounts while other characteristics are enhanced by lower amounts. The compositions allow many of the desirable characteristics of pure nondegradable polymers. In addition, the presence of plasticizer facilitates melt processing, and enhances the degradation rate of the compositions in contact with the wellbore environment. The intimately plasticized composition may be processed into a final product (e.g., a wellbore servicing foam) in a manner adapted to retain the plasticizer as an intimate dispersion in the polymer for certain properties. These can include: (1) quenching the composition at a rate adapted to retain the plasticizer as an intimate dispersion; (2) melt processing and quenching the composition at a rate adapted to retain the plasticizer as an intimate dispersion; and (3) processing the composition into a final product in a manner adapted to maintain the plasticizer as an intimate dispersion. In certain embodiments, the plasticizers are at least intimately dispersed within the aliphatic polyester.

In an embodiment, the biodegradable material comprises a poly(anhydride). Poly(anhydride) hydrolysis proceeds, inter alia, via free carboxylic acid chain-ends to yield carboxylic acids as final degradation products. The erosion time can be varied by variation of the polymer backbone. Examples of suitable poly(anhydrides) include without limitation poly(adipic anhydride), poly(suberic anhydride), poly(sebacic anhydride), and poly(dodecanedioic anhydride). Other suitable examples include but are not limited to poly(maleic anhydride) and poly(benzoic anhydride).

In an embodiment, the biodegradable polymer comprises polysaccharides, such as starches, cellulose, dextran, substituted galactomannans, guar gums, high-molecular weight polysaccharides composed of mannose and galactose sugars, galactomannans, heteropolysaccharides obtained by the fermentation of starch-derived sugar (e.g., xanthan gum), diutan, scleroglucan, derivatives thereof, or combinations thereof.

In an embodiment, the biodegradable polymer comprises guar or a guar derivative. Nonlimiting examples of guar derivatives suitable for use in the present disclosure include hydroxypropyl guar, carboxymethylhydroxypropyl guar, carboxymethyl guar, hydrophobically modified guars, guar-containing compounds, synthetic polymers, or combinations thereof.

In an embodiment, the biodegradable polymer comprises cellulose or a cellulose derivative. Nonlimiting examples of cellulose derivatives suitable for use in the present disclosure include cellulose ethers, carboxycelluloses, carboxyalkylhydroxyethyl celluloses, hydroxyethylcellulose, hydroxypropylcellulose, carboxymethylhydroxyethylcellulose, carboxymethylcellulose, or combinations thereof.

In an embodiment, the biodegradable polymer comprises a starch. Nonlimiting examples of starches suitable for use in the present disclosure include native starches, reclaimed starches, waxy starches, modified starches, pre-gelatinized starches, or combinations thereof.

In an embodiment, the degradable polymer comprises polyvinyl polymers, such as polyvinyl alcohols, polyvinyl acetate, partially hydrolyzed polyvinyl acetate, or combinations thereof.

In an embodiment, the degradable polymer comprises acrylic-based polymers, such as acrylic acid polymers, acrylamide polymers, acrylic acid-acrylamide copolymers, acrylic acid-methacrylamide copolymers, polyacrylamides, polymethacrylamides, partially hydrolyzed polyacrylamides, partially hydrolyzed polymethacrylamides, ammonium and alkali metal salts thereof, or combinations thereof.

In an embodiment, the degradable polymer comprises polyamides, such as polycaprolactam derivatives, poly-paraphenylene terephthalamide or combinations thereof. In an embodiment, the degradable polymer comprises Nylon 6,6; Nylon 6; KEVLAR, or combinations thereof.

In various embodiments, at least a portion of one or more of the reducible materials is self-degradable (e.g., self-degradable reducible materials). Namely, at least a portion of the one or more reducible materials is formed from biodegradable materials comprising a mixture of a degradable polymer, such as the aliphatic polyesters or poly(anhydrides) previously described, and a hydrated organic or inorganic solid compound. The degradable polymer will at least partially degrade in the releasable water provided by the hydrated organic or inorganic compound, which dehydrates over time when heated due to exposure to the wellbore environment.

Examples of the hydrated organic or inorganic solid compounds that can be utilized in the self-degradable reducible materials include, but are not limited to, hydrates of organic acids or their salts such as sodium acetate trihydrate, L-tartaric acid disodium salt dihydrate, sodium citrate dihydrate, hydrates of inorganic acids or their salts such as sodium tetraborate decahydrate, sodium hydrogen phosphate heptahydrate, sodium phosphate dodecahydrate, amylose, starch-based hydrophilic polymers, and cellulose-based hydrophilic polymers.

In some embodiments, the one or more reducible materials comprising one or more degradable materials of the type described herein are degraded subsequent to the performance of their intended function. Degradable materials and method of utilizing same are described in more detail in U.S. Pat. No. 7,093,664 which is incorporated by reference herein in its entirety.

In an embodiment, the reducible material may comprise Garolite. In an exemplary embodiment, the reducible material may comprise High-Temperature Garolite (G-11 Epoxy Grade). In other embodiments, the reducible material of the wellbore servicing foam may comprise resin or epoxy materials that are at least partially degradable by exposure to water.

In various embodiments, the reducible material may comprise a disintegrable material (e.g., disintegrable reducible material). Materials that can disintegrate include plastics such as PLA, polyamides and composite materials comprising degradable plastics and non-degradable fine solids. It should be noted that some degradable materials pass through a disintegration stage during the degradation process; an example is PLA, which turns into fragile materials before complete degradation. In an embodiment, disintegration of at least one portion of the wellbore servicing foam may yield smaller pieces that are flushed away or otherwise promote removal of the wellbore servicing foam.

In an embodiment, the reducible material may be included within the wellbore servicing foam in a suitable amount. In an embodiment, the reducible material is present within the wellbore servicing foam in an amount of from about 5 wt. % to about 95 wt. %, alternatively from about 10 wt. % to about 75 wt. %, or alternatively from about 20 wt. % to about 60 wt. %, based on the total weight of the wellbore servicing foam. Alternatively, the reducible material may comprise the balance of the wellbore servicing foam after considering the amount of the other components used.

In an embodiment, the wellbore servicing foam comprises a wellbore servicing material (e.g., a cargo) that is uniformly dispersed throughout the wellbore servicing foam. In an embodiment, the wellbore servicing material (e.g., a cargo) may comprise a salt, a weighting agent, a degradation accelerator, a surfactant, a corrosion inhibitor, a scale inhibitor, a clay stabilizer, a defoamer, a resin, a proppant, a breaker, a fluid loss agent, or combinations thereof. These wellbore servicing materials may be introduced singularly or in combination using any suitable methodology and in amounts effective to produce the desired improvements in wellbore servicing foam properties. As will appreciated by one of skill in the art with the help of this disclosure, any of the wellbore servicing materials used in the wellbore servicing foam have to be compatible with the reducible material used in the wellbore servicing foam composition. Further, as will appreciated by one of skill in the art with the help of this disclosure, when more than one wellbore servicing material is used in the wellbore servicing foam, the wellbore servicing materials used have to be compatible with each other and with the reducible material used in the wellbore servicing foam composition.

In some embodiments, the wellbore servicing material may function to adjust the density of the wellbore servicing foam, such that the density of the wellbore servicing foam is about equal to the density of the WSF, e.g., such that the wellbore servicing foam has neutral buoyancy with respect to the WSF.

As will be appreciated by one of skill in the art, and with the help of this disclosure, each type of wellbore servicing material may perform more than one function, e.g., a degradation accelerator may be used as a weighting agent to modulate the density of the wellbore servicing foam as well as an accelerator for the degradation of the reducible material.

In an embodiment, the wellbore servicing material comprises a salt. In an embodiment, the salt may be used as a weighting agent to modulate the density of the wellbore servicing foam. In an embodiment, the salt may function as a clay stabilizer upon release from the wellbore servicing foam, when the wellbore servicing foam is intended for use in a subterranean formation comprising sandstone comprising swelling clays (e.g., smectite), to avoid damaging such formation.

Nonlimiting examples of salts suitable for use in the present disclosure include a monovalent cation salt, an alkali metal salt, an inorganic monovalent salt, an organic monovalent salt, a multivalent cation salt, an alkaline earth metal salt, a transitional metal salt, an inorganic multivalent salt, an organic multivalent salt, a chloride salt, a bromide salt, a phosphate salt, a formate salt, NaCl, KCl, NaBr, CaCl₂, CaBr₂, ZnBr₂, ammonium chloride (NH₄Cl), potassium phosphate, sodium formate, potassium formate, cesium formate, ethyl formate, methyl formate, methyl chloro formate, triethyl orthoformate, trimethyl orthoformate, or combinations thereof.

In an embodiment, the wellbore servicing material comprises a weighting agent. Nonlimiting examples of weighting agents suitable for use in the present disclosure include hematite, magnetite, iron oxides, magnesium oxides, illmenite, barite, siderite, celestite, dolomite, calcite, halite, salts of the type described previously herein, or combinations thereof.

In an embodiment, the wellbore servicing material comprises a degradation accelerator. In an embodiment, a degradation accelerator comprises a material that functions to enhance the rate of degradation of the reducible material of the wellbore servicing foam. The reducible material of the wellbore servicing foam may be degraded via hydrolytic or aminolytic degradation in the presence of a degradation accelerator. In an embodiment, the degradation accelerator comprises an inorganic base, an organic base, an acid, a pH-modifying material precursor (e.g., base precursor, acid precursor), or combinations thereof.

In an embodiment, the degradation accelerator comprises a pH-modifying material precursor. Herein a pH-modifying material precursor (e.g., base precursor, acid precursor) is defined as a material or combination of materials that provides for delayed release of one or more acidic or basic species. Such pH-modifying material precursors may also be referred to as time-delayed and/or time-released acids or bases. In some embodiments, the pH-modifying material precursors comprise a material or combination of materials that may react to generate and/or liberate an acid or a base after a period of time has elapsed. The liberation of the acidic or basic species from the pH-modifying material precursor may be accomplished through any means known to one of ordinary skill in the art with the benefits of this disclosure and compatible with the user-desired applications.

In some embodiments, pH-modifying material precursors may be formed by modifying acids or bases via the addition of an operable functionality or substituent, physical encapsulation or packaging, or combinations thereof. The operable functionality or substituent may be acted upon in any fashion (e.g., chemically, physically, thermally, etc.) and under any conditions compatible with the components of the process in order to release the acid or the base at a some user and/or process desired time and/or under desired conditions such as in situ wellbore conditions. In an embodiment, the pH-modifying material precursor may comprise at least one modified acid or base (e.g., having an operable functionality, encapsulation, packaging, etc.) such that when acted upon and/or in response to pre-defined conditions (e.g., in situ wellbore conditions such as temperature, pressure, chemical environment), an acid or base is released. In an embodiment, the pH-modifying material precursor may comprise an acidic or basic species that is released after exposure to an elevated temperature such as an elevated wellbore temperature (e.g., greater than about 50° F.). In an embodiment, the pH-modifying material precursor comprises a material which reacts with one or more components of the wellbore servicing fluid (e.g., reacts with an aqueous fluid present in the wellbore environment upon release of the wellbore servicing material from the wellbore servicing foam) to liberate at least one acidic or basic species.

A pH-modifying material precursor as used herein generally refers to a component, which itself does not act as an acid or base by significantly modifying the pH of a solution into which it is introduced, but which, upon degradation, will yield one or more components capable of acting as an acid or a base by modifying the pH of that solution. For example, in an embodiment a pH-modifying material precursor may yield one or more components capable of modifying the pH of a solution by about 0.1 pH units, alternatively about 0.2 pH units, alternatively about 0.5 pH units, alternatively about 1.0 pH units, alternatively about 1.5 pH units, alternatively about 2.0 pH units, alternatively about 2.5 pH units, alternatively about 3.0 pH units, alternatively about 4.0 pH units, alternatively about 5.0 pH units, alternatively about 6.0 pH units, or alternatively about 7.0 or more pH units and such modifications may be an increase or decrease in pH.

In an embodiment, the pH-modifying material precursor may be characterized as exhibiting a suitable delay time. As used herein, the term “delay time” refers to the period of time from when a pH-modifying material precursor, or a combination of pH-modifying material precursors, is introduced into an operational environment until the pH-modifying material precursor or combination of precursors begins to alter (e.g., begins to degrade) the reducible material of the wellbore servicing foam. In an embodiment, the pH-modifying material precursor may exhibit an average delay time of at least about 1 hour, alternatively at least about 2 hours, alternatively at least about 4 hours, alternatively at least about 8 hours, alternatively at least about 12 hours, alternatively at least about 24 hours.

In an embodiment, the pH-modifying material precursor may be characterized as operable, as disclosed herein, within a suitable temperature range. As will be appreciated by one of skill in the art viewing this disclosure, differing pH-modifying material precursors may exhibit varying temperature ranges of operability. As such, in an embodiment, a pH-modifying material precursor, or combination of pH-modifying material precursors, may be selected for inclusion in the reducible material of the wellbore servicing foam such that the pH-modifying material precursor(s) exhibit a desired operable temperature range (e.g., an ambient downhole temperature for a given wellbore). In addition, as will also be appreciated by one of skill in the art viewing this disclose, the degradation of the pH-modifying material precursor may be influenced by the temperature of the operational environment. For example, generally the rate of degradation of a given pH-modifying material precursor will be higher at higher temperatures. As such, the rate of degradation of a given pH-modifying material precursor may be generally higher when exposed to the environment within the wellbore. In an embodiment, the pH-modifying material precursor suitable for use in the present disclosure may exhibit an operable temperature range of from about 50° F. to about 700° F., alternatively from about 80° F. to about 500° F., or alternatively from about 90° F. to about 450° F.

In an embodiment, the pH modifying material precursor is an acid precursor. In an embodiment, the acid precursor comprises a reactive ester. Hereinafter, the disclosure will focus on the use of a reactive ester as the acid precursor with the understanding that other acid precursors may be used in various embodiments. The reactive ester may be converted to an acidic species by hydrolysis of the ester linkage, for example by contact with water present in the WSF and/or water present in situ in the wellbore. Nonlimiting examples of acid precursors suitable for use in the present disclosure include monoethylene monoformate, monoethylene diformate, ethylene glycol monoformate, ethylene glycol diformate, diethylene glycol monoformate, diethylene glycol diformate, triethylene glycol diformate, glyceryl monoformate, glyceryl diformate, glyceryl triformate; formate esters of pentaerythritol, tri-n-propyl orthoformate, tri-n-butyl orthoformate, methyl lactate, ethyl lactate, propyl lactate, butyl lactate, trilactin, polylactic acid, poly(lactides), methyl acetate, ethyl acetate, propyl acetate, butyl acetate, monoacetin, diacetin, triacetin, glyceryl diacetate, glyceryl triacetate, tripropionin (a triester of propionic acid and glycerol), methyl glycolate, ethyl glycolate, propyl glycolate, butyl glycolate, poly(glycolides), or combinations thereof. Other examples of acid precursors suitable for use as degradation accelerators in this disclosure are described in more detail in U.S. Pat. Nos. 6,877,563; 7,021,383 and 7,455,112 and U.S. Patent Application Nos. 20070169938 A1 and 20070173416 A1, each of which is incorporated by reference herein in its entirety.

In an embodiment, the degradation accelerator comprises an acid. Nonlimiting examples of acids suitable for use in the present disclosure include formic acid; acetic acid; lactic acid; glycolic acid; oxalic acid; propionic acid; butyric acid; monochloroacetic acid; dichloroacetic acid; trichloroacetic acid; hydrochloric acid; sulphuric acid; sulphonic acid; para-toluene sulfonic acid; sulphinic acid; phosphoric acid; phosphorous acid; phosphonic acid; phosphinic acid; sulphamic acid; or combinations thereof.

In an embodiment, the pH-modifying material precursor is a base precursor. A base precursor (i.e., base-producing material) includes any compound capable of generating hydroxyl ions (HO) in water to react with or neutralize an acid to from a salt. It is to be understood that the base-producing material can include chemicals that produce a base when reacted together. Without limitation, examples include reaction of an oxide with water Nonlimiting examples of base-producing materials suitable for use in this disclosure include ammonium, alkali and alkali earth metal carbonates and bicarbonates, alkali and alkali earth metal oxides, alkali and alkali earth metal hydroxides, alkali and alkali earth metal phosphates and hydrogen phosphates, alkali and alkaline earth metal sulphides, alkali and alkaline earth metal salts of silicates and aluminates, water soluble or water dispersible organic amines, polymeric amines, amino alcohols, or combinations thereof. Other examples of bases suitable for use as degradation accelerators in this disclosure are described in more detail in U.S. Patent Publication No. 20100273685 A1, which is incorporated by reference herein in its entirety.

Nonlimiting examples of alkali and alkali earth metal carbonates and bicarbonates suitable for use in this disclosure include Na₂CO₃, K₂CO₃, CaCO₃, MgCO₃, NaHCO₃, KHCO₃. It is to be understood that when carbonate and bicarbonate salts are used as base-producing material, a byproduct may be carbon dioxide.

Nonlimiting examples of alkali and alkali earth metal hydroxides suitable for use in this disclosure include NaOH, NH₄OH, KOH, LiOH, and Mg(OH)₂.

Nonlimiting examples of alkali and alkali earth metal oxides suitable for use in this disclosure include BaO, SrO, Li₂O, CaO, Na₂O, K₂O, MgO, and the like. Nonlimiting examples of alkali and alkali earth metal phosphates and hydrogen phosphates suitable for use in this disclosure include Na₃PO₄, C₃(PO₄)₂, CaHPO₄, KH₂PO₄, and the like. Nonlimiting examples of alkali and alkali earth metal sulphides suitable for use in this disclosure include Na₂S, CaS, SrS, and the like.

Nonlimiting examples of silicate salts suitable for use in this disclosure include sodium silicate, potassium silicate, sodium metasilicate, and the like. Nonlimiting examples of aluminate salts suitable for use in this disclosure include sodium aluminate, calcium aluminate, and the like.

Nonlimiting examples of organic amines suitable for use in this disclosure include polymeric amines, monomeric amines containing one or more amine groups, oligomeric amines, oligomers of aziridine, triethylene tetramine, tetraethylene pentamine, secondary amines, tertiary amines. The organic amines may be completely or partially soluble in water.

Nonlimiting examples of water soluble or water dispersible amines suitable for use in this disclosure include triethylamine, aniline, dimethylaniline, ethylenediamine, diethylene triamine, cyclohexylamine, diethyltoluene diamine, 2,4,6-tri-dimethylaminomethylphenol, isophoroneamine, and the like.

Nonlimiting examples of polymeric amines suitable for use in this disclosure include polylysine, poly(dimethylaminoethylmethacrylate), poly(ethyleneimine), poly(vinylamine-co-vinylalcohol), poly(vinylamine), and the like.

Nonlimiting examples of amino alcohols (i.e., alkanolamines) suitable for use in this disclosure include ethanolamine, triethanolamine, tripropanolamine, and the like.

In an embodiment, the wellbore servicing material comprises a surfactant. Generally a surfactant functions to improve compatibility between fluids (e.g., wellbore servicing fluids, fluids naturally present in a subterranean formation, etc.) or compatibility between a fluid (e.g., wellbore servicing fluids, fluids naturally present in a subterranean formation, etc.) and a solid surface (e.g., a subterranean formation surface, a surface of a particulate material introduced into the wellbore, etc.), by lowering the surface tension between the fluids or the fluid and the surface, respectively. Nonlimiting examples of surfactants suitable for use as wellbore servicing materials in the present disclosure include ethoxylated nonyl phenol phosphate esters, nonionic surfactants, cationic surfactants, anionic surfactants, amphoteric/zwitterionic surfactants, alkyl phosphonate surfactants, linear alcohols, nonylphenol compounds, alkyoxylated fatty acids, alkylphenol alkoxylates, ethoxylated amides, ethoxylated alkyl amines, betaines, methyl ester sulfonates, hydrolyzed keratin, sulfosuccinates, taurates, amine oxides, alkoxylated fatty acids, alkoxylated alcohols, lauryl alcohol ethoxylate, ethoxylated nonyl phenol, ethoxylated fatty amines, ethoxylated alkyl amines, cocoalkylamine ethoxylate, betaines, modified betaines, alkylamidobetaines, cocamidopropyl betaine, quaternary ammonium compounds, trimethyltallowammonium chloride, trimethylcocoammonium chloride, or combinations thereof.

Other examples of surfactants that may be suitable for use as wellbore servicing materials in the present disclosure include without limitation CFS-485 casing cleaner, LOSURF-300M surfactant, LOSURF-357 surfactant, LOSURF-400 surfactant, LOSURF-2000S surfactant, LOSURF-2000M surfactant, LOSURF-259 nonemulsifier, NEA-96M surfactant, BDF-442 surfactant, and BDF-443 surfactant. CFS-485 casing cleaner is a blend of surfactants and alcohols; LOSURF-300M surfactant is a nonionic surfactant; LOSURF-357 surfactant is a nonionic liquid surfactant; LOSURF-400 surfactant is a nonemulsifier; LOSURF-2000S surfactant is a blend of an anionic nonemulsifier and an anionic hydrotrope; LOSURF-2000M surfactant is a solid surfactant; LOSURF-259 nonemulsifier is a nonionic, nonemulsfier blend; NEA-96M surfactant is a general surfactant and nonemulsifier; BDF-442 surfactant and BDF-443 surfactant are acid-responsive surfactants; all of which are commercially available from Halliburton Energy Services.

In some embodiments, the surfactant comprises a microemulsion additive. Nonlimiting examples of microemulsion additives suitable for use as wellbore servicing materials in the present disclosure include PEN-88M surfactant, PEN-88HT surfactant, SSO-21E surfactant, SSO-21MW agent, and GASPERM 1000 service. PEN-88M surfactant is a nonionic penetrating surfactant; PEN-88HT surfactant is a high-temperature surfactant; SSO-21E surfactant is a foaming surfactant; SSO-21MW agent is a foaming surfactant and GASPERM 1000 service is a microemulsion; all of which are commercially available from Halliburton Energy Services, Inc.

In an embodiment, the wellbore servicing material comprises a corrosion inhibitor. Without wishing to be limited by theory, a corrosion inhibitor is generally a chemical compound that may function to decrease (e.g., reduce, slow down, or lessen) the corrosion rate of a material, such as a metal or an alloy, typically by forming a coating, often a passivation layer, which prevents access of the corrosive substance to the metal or alloy.

In an embodiment, the corrosion inhibitor comprises a quaternary ammonium compound; unsaturated carbonyl compounds, 1-phenyl-1-ene-3-butanone, cinnamaldehyde; unsaturated ether compounds, 1-phenyl-3-methoxy-1-propene; unsaturated alcohols, acetylenic alcohols, methyl butynol, methyl pentynol, hexynol, ethyl octynol, propargyl alcohol, benzylbutynol, ethynylcyclohexanol; Mannich condensation products (such as those formed by reacting an aldehyde, a carbonyl containing compound and a nitrogen containing compound); condensation products formed by reacting an aldehyde in the presence of an amide; polysaccharides, inulin, tannins, tannic acid, catechin, epicatechin, epigallocatechin, epicatechingallate; formamide, formic acid, formates; other sources of carbonyl; iodides; fluorinated surfactants; quaternary derivatives of heterocyclic nitrogen bases; quaternary derivatives of halomethylated aromatic compounds; terpenes; aromatic hydrocarbons; coffee, tobacco, gelatin; derivatives thereof, and the like, or combinations thereof. Corrosion inhibitors suitable for use in the present disclosure are described in more detail in U.S. Pat. Nos. 3,077,454; 5,697,443; 7,621,334; U.S. Publication Nos. 20120238479 A1, 20120142563 A1, and 20120145401 A1, each of which is incorporated by reference herein in its entirety.

In an embodiment, the corrosion inhibitor comprises a quaternary ammonium compound of the general formula (R³)₄N⁺X⁻, wherein the R³ groups represent the same or different long chain alkyl, cycloalkyl, aryl or heterocyclic groups and X represents an anion, such as for example a halide. Nonlimiting examples of quaternary ammonium compounds suitable for use in the present disclosure include N-alkyl, N-cycloalkyl and N-alkylaryl pyridinium halides, such as N-cyclohexylpyridinium bromide, N-octylpyridinium bromide, N-nonylpyridinium bromide, N-decylpyridinium bromide, N-dodecylpyridinium bromide, N,N-didodecyldipyridinium dibromide, N-tetradecylpyridinium bromide, N-laurylpyridinium chloride, N-dodecylbenzylpyridinium chloride, N-dodecylquinolinium bromide, N-(1-methylnapthyl)quinolinium chloride, N-benzyl)quinolinium chloride, monochloromethylated and bischloromethylated pyridinium halides, ethoxylated and propoxylated quaternary ammonium compounds, sulfated ethoxylates of alkyl phenols and primary and secondary fatty alcohols, didodecyldimethylammonium chloride, hexadecylethyldimethylammonium chloride, 2-hydroxy-3-(2-undecylamidoethylamino)-propane-1-triethylammonium hydroxide, 2-hydroxy-3-(2-heptadecylamidoethylamino)-propane-1-triethylammonium hydroxide, 2-hydroxy-3-(2-heptadecylamidoethylamino)-propane-1-triethylammonium hydroxide, and the like, or combinations thereof.

Nonlimiting examples of commercially available corrosion inhibitors suitable for use in the present disclosure include MSA-II corrosion inhibitor, MSA-III corrosion inhibitor, HAI-25E+ environmentally friendly low temp corrosion inhibitor, HAI-404 acid corrosion inhibitor, HAI-50 inhibitor, HAI-60 corrosion inhibitor, HAI-62 acid corrosion inhibitor, HAI-65 corrosion inhibitor, HAI-72E+ corrosion inhibitor, HAI-75 high temperature acid inhibitor, HAI-81M acid corrosion inhibitor, HAI-85 acid corrosion inhibitor, HAI-85M acid corrosion inhibitor, HAI-202 environmental corrosion inhibitor, HAI-OS corrosion inhibitor, HAI-GE corrosion inhibitor, FDP-S692-03 corrosion inhibitor for organic acids, FDP-S656AM-02 environmental corrosion inhibitor system and FDP-S656BW-02 environmental corrosion inhibitor system, all of which are available from Halliburton Energy Services, Inc.

In an embodiment, a corrosion inhibitor intensifier may be used with a corrosion inhibitor. A corrosion inhibitor intensifier may function to enhance the activity of the corrosion inhibitor, e.g., decrease further the corrosion rate. Nonlimiting examples of commercially available corrosion inhibitor intensifiers suitable for use in the present disclosure include HII-500 corrosion inhibitor intensifier, HII-500M corrosion inhibitor intensifier, HII-124 acid inhibitor intensifier, HII-124B acid inhibitor intensifier, HII-124C inhibitor intensifier, and HII-124F corrosion inhibitor intensifier, all of which are available from Halliburton Energy Services, Inc.

In an embodiment, the wellbore servicing material comprises a breaker or a breaking agent. Generally, a breaker refers to a compound that functions to remove at least a portion of a filter cake from a wellbore and/or subterranean formation. In an embodiment, a breaker may comprises an enzyme, an oxidant, a chelating agent, or combinations thereof.

In an embodiment, the breaker comprises xanthanase, which is an enzyme configured for the degradation of xanthan polymers. Xanthanase may also be employed within the wellbore servicing foam as a catalyst of ester hydrolysis, e.g., to promote/enhance the degradation of the reticulated material of the wellbore servicing foam. An example of a xanthanase suitable for use in the present disclosure is commercially available from Halliburton Energy Services, Inc. as a part of the N-FLOW line of service formulations. The use of enzymes (e.g., xanthanases) as breaking agents is described in more detail in U.S. Pat. Nos. 4,996,153; 5,881,813; and 6,110,875; each of which is incorporated by reference herein in its entirety.

In an embodiment, the breaker is an oxidant. Nonlimiting examples of oxidants suitable for use in the present disclosure include an oxide, a peroxide, a perborate, sodium perborate, GBW-40 breaker, SP breaker, OXOL II breaker, or combinations thereof. GBW-40 breaker is a strong oxidizer breaker, SP breaker is a water-soluble oxidizing breaker and OXOL II breaker is a delayed release oxidizing breaker, all of which are commercially available from Halliburton Energy Services, Inc.

In an embodiment, the breaker is a chelating agent. Nonlimiting examples of chelating agents suitable for use in the present disclosure include ethylenediaminetetraacetic acid, dimercaptosuccinic acid, dimercapto-propane sulfonate, α-lipoic acid, calcium disodium versenate, D-penicillamine, deferoxamine, defarasirox, dimercaprol, glutamic acid, diacetic acid, or combinations thereof.

In an embodiment, the wellbore servicing material may be included within the wellbore servicing foam in a suitable amount. In an embodiment, the wellbore servicing material is present within the wellbore servicing foam in an amount of from about 5 wt. % to about 95 wt. %, alternatively from about 25 wt. % to about 90 wt. %, or alternatively from about 40 wt. % to about 80 wt. %, based on the total weight of the wellbore servicing foam.

In an embodiment, wellbore servicing foams of the type described herein may be prepared using any suitable methodology compatible with the methods of the present disclosure. Methods of foaming materials of the type disclosed herein (e.g., reticulated materials) include without limitation gas foaming, chemical agent foaming, injection molding, compression molding, extrusion molding, extrusion, melt extrusion, pressure reduction/vacuum induction, or any suitable combination of these methods.

In an embodiment, the wellbore servicing foam may be prepared from a composition comprising a reducible material, a wellbore servicing material and a foaming agent. The foaming agent may be any foaming agent compatible with the other components of the wellbore servicing foam, such as for example physical blowing agents, chemical blowing agents, and the like.

In an embodiment, the foaming agent is a physical blowing agent. Physical blowing agents are typically nonflammable gases that are able to evacuate the composition quickly after the foam is formed. Examples of physical blowing agents include without limitation air, carbon dioxide (CO₂), nitrogen (N₂), pressurized liquids, water vapor, steam, propane, n-butane, isobutane, pentane, n-pentane, 2,3-dimethylpropane, 1-pentene, cyclopentene, n-hexane, 2-methylpentane, 3-methylpentane, 2,3-dimethylbutane, 1-hexene, cyclohexane, n-heptane, 2-methylhexane, 2,2-dimethylpentane, 2,3-dimethylpentane, and combinations thereof. In an embodiment, the physical blowing agent is incorporated into the wellbore servicing foam composition in an amount of from about 0.1 wt. % to about 10 wt. %, alternatively from about 0.1 wt. % to about 5.0 wt. % , or alternatively from about 0.5 wt. % to about 2.5 wt. %, wherein the weight percent is based on the total weight of the wellbore servicing foam composition.

In an embodiment, the foaming agent is a chemical foaming agent, which may also be referred to as a chemical blowing agent. A chemical foaming agent is a chemical compound that decomposes endothermically at elevated temperatures. A chemical foaming agent suitable for use in this disclosure may decompose at temperatures of from about 250° F. to about 570° F., alternatively from about 330° F. to about 400° F. Decomposition of the chemical foaming agent generates gases that become entrained in the polymer thus leading to the formation of voids within the polymer. In an embodiment, a chemical foaming agent suitable for use in this disclosure may have a total gas evolution of from about 20 ml/g to about 200 ml/g, alternatively from about 75 ml/g to about 150 ml/g, or alternatively from about 110 ml/g to about 130 ml/g. Nonlimiting examples of chemical foaming agent suitable for use in the present disclosure include carbonic acids, carboxylic acids, polycarboxylic acids, salts thereof, or combinations thereof. Examples of commercial chemical foaming agents suitable for use in this disclosure include without limitation SAFOAM FP-20, SAFOAM FP-40, SAFOAM FPN3-40, all of which are available from Reedy International Corporation. In an embodiment, the chemical foaming agent may be incorporated in the wellbore servicing foam composition (e.g., reducible material, wellbore servicing material) in an amount of from about 0.10 wt. % to about 5 wt. % by total weight of the wellbore servicing foam composition, alternatively from 0.25 about wt. % about to 2.5 wt. %, or alternatively from about 0.5 wt. % to about 2 wt. %.

In an embodiment, the wellbore servicing foam is prepared by contacting the reducible material with the wellbore servicing material and the foaming agent, and thoroughly mixing the resulting composition, for example by extrusion, as will be described later herein. In an embodiment, the reducible material is plasticized or melted by heating in an extruder and is contacted and mixed thoroughly with a wellbore servicing material and a foaming agent of the type disclosed herein at a temperature of less than about 350° F. Alternatively, the reducible material may be contacted with the wellbore servicing material and the foaming agent prior to introduction of the reducible material to the extruder (e.g., via bulk mixing), during the introduction of the reducible material to an extruder, or combinations thereof.

The reducible materials of this disclosure may be converted to foamed particles by any suitable method. The wellbore servicing foam particles may be produced about concurrently with the mixing and/or foaming of the reducible materials (e.g., on a sequential, integrated process line) or may be produced subsequent to mixing and/or foaming of the reducible materials (e.g., on a separate process line such as an end use compounding and/or thermoforming line). In an embodiment, the reducible material is mixed with a wellbore servicing material and foamed via extrusion, thereby forming a molten mixture, and the molten mixture is fed to a shaping process (e.g., mold, die, lay down bar, etc.) where the wellbore servicing foam is shaped. The foaming of the reducible material may occur prior to, during, or subsequent to the shaping. In an embodiment, molten reducible material is injected into a mold, where the reducible material undergoes foaming and fills the mold to form a wellbore servicing foam shaped article (e.g., beads, block, sheet, and the like), which may be subjected to further processing steps (e.g., grinding, milling, shredding, etc.).

In an embodiment, the wellbore servicing foam is further processed by mechanically sizing, grinding, cutting or, chopping the wellbore servicing foam into particles using any suitable methodologies for such processes, such as for example a pellet mill. The wellbore servicing foam suitable for use in this disclosure comprises foamed particles of any suitable geometry, including without limitation beads, hollow beads, spheres, ovals, fibers, rods, pellets, platelets, disks, plates, ribbons, and the like, or combinations thereof.

In an embodiment, a process for preparing a wellbore servicing foam comprises introducing a reducible material and a wellbore servicing material to an extruder to form a melt mixture. In such embodiment, the melt mixture may further comprise a foaming agent.

In an embodiment, the extruder may comprises a single-screw extruder or a twin-screw extruder. Nonlimiting examples of twin-screw extruders suitable for use in the present disclosure include a counter-rotating intermeshing twin-screw extruder, a counter-rotating non-intermeshing twin-screw extruder, a co-rotating intermeshing twin-screw extruder, or a co-rotating non-intermeshing twin-screw extruder.

In an embodiment, the twin-screw extruders have the capability to generate heat by using heat generated by an electrical source surrounding an extruder barrel; heat generated by hot liquid jackets surrounding the extruder barrel; heat generated by steam jackets surrounding the extruder barrel; heat generated by steam injection at various ports along the extruder barrel; heat generated by viscous dissipation or friction (e.g., frictional heat); or combinations thereof.

In an embodiment, a process for preparing a wellbore servicing foam by extrusion may comprise feeding dry materials (e.g., reducible material, wellbore servicing material) at the entry of the extruder (e.g., extruder throat, extruder hopper, etc.), and it may further comprise the option of feeding additional dry ingredients (e.g., wellbore servicing material) within the first about 65%, alternatively about 50%, or alternatively 25% of the total extruder barrel length. In an embodiment, a foaming agent, such as for example a pressurized liquid (e.g., water vapor) may be added at one or more injection ports along the entire length of the extruder.

In an embodiment, the reducible material and the wellbore servicing material are transported along the extruder barrel (e.g., by using either a single screw or multiple screws and/or lobes, such as for example co-rotating intermeshing screws or counter-rotating screws), and heated to a predetermined temperature to form a melt mixture. In an embodiment, the extruder barrel may be heated by frictional dissipation or via direct convection/conduction heat being transferred from the barrel jackets of the extruder. In an embodiment, the extruder barrel may be heated at a temperature of from about 120° F. to about 400° F., alternatively from about 120° F. to about 300° F., or alternatively from about 120° F. to about 250° F.

In an embodiment, the melt mixture may be injected with a physical blowing agent, such as for example water vapor, steam, CO₂ and/or N₂. In an alternative embodiment, the reducible material alone is melted in a first step, followed by injection with a physical blowing agent and mixing or blending with a wellbore servicing material, to form a melt mixture.

In an embodiment, the melt mixture may flow into a multiple hole die assembly located at the end of the extruder, and as the melt mixture exits through the die hole it expands and cools down, thereby forming the wellbore servicing foam. In an alternative embodiment, the melt mixture may be pumped or extruded into a pelleting mill, wherein a planetary system of rotating press wheels physically force the melt mixture into the die holes. In an embodiment, the die hole may have a diameter in the range of from about 2 microns to about 2000 microns, alternatively from about 5 microns to about 1500 microns, or alternatively from about 10 microns to about 1000 microns.

In an embodiment, the environment surrounding the exit of the extruder die (e.g., the location on the extruder where the hole die assembly is located) may be kept pressurized by water vapor or other suitable liquid vapor. In an embodiment, the environment surrounding the exit of the extruder die may be kept pressurized at a pressure of from about 5 psig to about 250 psig, alternatively from about 10 psig to about 200 psig, or alternatively from about 15 psig to about 150 psig.

As the extrudate material (e.g., wellbore servicing foam) exits the die hole, it may be cut with a die cutter knife. In an embodiment, the outer diameter of the extrudate wellbore servicing foam may be the same as the diameter of the die hole and may be in the range of from about 10 microns to about 6500 microns, alternatively from about 50 microns to about 2500 microns, or alternatively from about 150 microns to about 1000 microns. In an embodiment, the extrudate wellbore servicing foam may be cut into lengths that are from about 0.25 to about 5 times the outer diameter of the extrudate wellbore servicing foam, alternatively from about 0.5 to about 5 times the outer diameter of the extrudate wellbore servicing foam, or alternatively from about 1 to about 2.5 times the outer diameter of the extrudate wellbore servicing foam. In an embodiment, the extrudate wellbore servicing foam may then be cooled by using water baths, water spray jets, air showers, liquid nitrogen, liquid carbon dioxide, or combinations thereof. In an embodiment, the extrudate wellbore servicing foam may then be dried, e.g., by using a hot gas such as hot air. The extrudate wellbore servicing foam may then be subjected to a step of mechanically sizing, such as for example grinding, to obtain the wellbore servicing foam comprising the desired particle size.

As will be appreciated by one of skill in the art, and with the help of this disclosure, the properties of the wellbore servicing foam can be modulated by varying at least one extrusion process parameter, such as for example number of die holes, size of holes, flow rate through the holes, length of die holes, pressure and temperature of material entering the die, temperature of the die assembly, and pressure surrounding the exit of the die, the speed of the die cutter knife, etc. In an embodiment, one or more of the extrusion process parameters may be used via a group of sensors and digital data capture means, to control the extrusion process by manual means or automatic devices controlled by a process logic controller (PLC). In an embodiment, multiple flighted screws may be used during the extrusion process.

In an embodiment, the porosity of the wellbore servicing foam may be controlled via a Maxwellian die swell process control model according to Equation 3:

$${P}_{swell} = \frac{{A}_{0} {{Γ}^{m - 2} ( \frac{Δ {P}_{die}}{{( L / D )}_{die}} )}^{2}}{{Γ}^{2 n - 2} {e}^{- Δ E ( 1 / {T}_{ref} - 1 / T ) / R}} \qquad ( 3 )$$

wherein P_{swell} is a die pressure at the exit of the die hole; A₀ is a rheological material constant determined by stress/strain measurements; Γ is a shear rate on an inside wall of the die; m is a material constant obtained by measuring normal stress differences in a normal force rheometer; ΔP_{die} is a differential pressure across the die; (L/D)_{die} is a ratio of length to diameter of a single die hole; n is a power law shear thinning index measured by conventional shear stress shear rate rheometry; ΔE is an activation energy; T_{ref} is a temperature at which rheology measurements are made; T is a temperature of an extrudate material (e.g., extrudate wellbore servicing foam) exiting the die; and R is universal gas constant.

In an embodiment, a process for making the wellbore servicing foam comprises the steps of (i) using co-rotating intermeshing screws or lobes to convey (e.g., move along the extruder barrel) the reducible material while being heated by frictional dissipation or via direct convection/conduction heat being transferred from the barrel jackets of the extruder to form a melt mixture, wherein the melt mixture may be injected with CO₂ or N₂ gas and blended with the wellbore servicing material, such as for example a weighting agent and/or a breaker; (ii) extruding the melt mixture through a die assembly to form an extrudate wellbore servicing foam, wherein the die assembly comprises a die hole with a diameter ranging from about 2 microns to about 2000 microns; (iii) cutting the extrudate wellbore servicing foam into lengths that are from about 0.25 to about 5 times the diameter of the die hole, wherein the environment surrounding the exit of the extruder die may be kept pressurized by water vapor or other suitable liquid vapor, and wherein the properties of the wellbore servicing foam such as for example the porosity and the reticulation may be accurately controlled by using a Maxwellian die swell process control model according to Equation 3, wherein the rheological material constant, the material constant, the shear thinning index, temperature and pressure may be used to control the throughput of the process and net final expansion ratio (e.g., porosity, reticulation, etc.); (iv) cooling the extrudate wellbore servicing foam; (v) drying the extrudate wellbore servicing foam; and (vi) mechanically sizing (e.g., grinding) the extrudate wellbore servicing foam into a plurality of wellbore servicing foam particles comprising the desired particle size.

In an embodiment, a process for making the wellbore servicing foam comprises the steps of (i) using co-rotating intermeshing screws or lobes to convey (e.g., move along the extruder barrel) the reducible material while being heated by frictional dissipation or via direct convection/conduction heat being transferred from the barrel jackets of the extruder to form a melt mixture, wherein the melt mixture may be injected with CO₂ or N₂ gas and blended with the wellbore servicing material, such as for example a weighting agent and/or a breaker; (ii) extruding or pumping the melt mixture into a pelleting mill, wherein a planetary system of rotating press wheels physically force the melt mixture into the die holes to form an extrudate wellbore servicing foam, wherein the die hole may have a diameter in the range of from about 2 microns to about 2000 microns; (iii) cutting the extrudate wellbore servicing foam into lengths that are from about 0.25 to about 5 times the diameter of the die hole, wherein the environment surrounding the exit of the extruder die may be kept pressurized by water vapor or other suitable liquid vapor, and wherein the properties of the wellbore servicing foam such as for example the porosity and the reticulation may be accurately controlled by using a Maxwellian die swell process control model according to Equation 3, wherein the rheological material constant, the material constant, shear thinning index, temperature and pressure may be used to control the throughput of the process and net final expansion ratio (e.g., porosity, reticulation, etc.); (iv) cooling the extrudate wellbore servicing foam; (v) drying the extrudate wellbore servicing foam; and (vi) mechanically sizing (e.g., grinding) the extrudate wellbore servicing foam into a plurality of wellbore servicing foam particles comprising the desired particle size.

In an embodiment, the WSF comprises an aqueous base fluid. Herein, an aqueous base fluid refers to a fluid having equal to or less than about 20 vol. %, 15 vol. %, 10 vol. %, 5 vol. %, 2 vol. %, or 1 vol. % of a non-aqueous fluid based on the total volume of the WSF. Aqueous base fluids that may be used in the WSF include any aqueous fluid suitable for use in subterranean applications, provided that the aqueous base fluid is compatible with the wellbore servicing foam used in the WSF. For example, the WSF may comprise water or a brine. In an embodiment, the base fluid comprises an aqueous brine. In such an embodiment, the aqueous brine generally comprises water and an inorganic monovalent salt, an inorganic multivalent salt, or both. The aqueous brine may be naturally occurring or artificially-created. Water present in the brine may be from any suitable source, examples of which include, but are not limited to, sea water, tap water, freshwater, water that is potable or non-potable, untreated water, partially treated water, treated water, produced water, city water, well-water, surface water, or combinations thereof. The salt or salts in the water may be present in an amount ranging from greater than about 0% by weight to a saturated salt solution, alternatively from about 0 wt. % to about 35 wt. %, alternatively from about 1 wt. % to about 30 wt. %, or alternatively from about 5 wt. % to about 10 wt. %, based on the weight of the salt solution. In an embodiment, the salt or salts in the water may be present within the base fluid in an amount sufficient to yield a saturated brine. In an embodiment, the aqueous base fluid may comprise the balance of the WSF after considering the amount of the other components used.

Nonlimiting examples of aqueous brines suitable for use in the present disclosure include chloride-based, bromide-based, phosphate-based or formate-based brines containing monovalent and/or polyvalent cations, salts of alkali and alkaline earth metals, or combinations thereof. Additional examples of suitable brines include, but are not limited to: NaCl, KCl, NaBr, CaCl₂, CaBr₂, ZnBr₂, ammonium chloride (NH₄Cl), potassium phosphate, sodium formate, potassium formate, cesium formate, ethyl formate, methyl formate, methyl chloro formate, triethyl orthoformate, trimethyl orthoformate, or combinations thereof. In an embodiment, the aqueous fluid comprises a brine. The brine may be present in an amount of from about 0 wt. % to about 30 wt. %, alternatively from about 0 wt. % to about 20 wt. %, or alternatively from about 0 wt. % to about 15 wt. %, based on the total weight of the WSF. Alternatively, the aqueous base fluid may comprise the balance of the WSF after considering the amount of the other components used.

The WSF may further comprise additional additives as deemed appropriate for improving the properties of the fluid. Such additives may vary depending on the intended use of the fluid in the wellbore. Examples of such additives include, but are not limited to, particulate materials, proppants, gravel, viscosifying agents, viscosifiers, gelling agents, crosslinkers, suspending agents, clays, clay control agents, breaking agents, breakers, fluid loss control additives, coupling agents, silane coupling agents, surfactants, emulsifiers, dispersants, flocculants, pH adjusting agents, bases, acids, mutual solvents, corrosion inhibitors, relative permeability modifiers, lime, weighting agents, glass fibers, carbon fibers, conditioning agents, water softeners, foaming agents, salts, oxidation inhibitors, scale inhibitors, thinners, scavengers, gas scavengers, lubricants, friction reducers, antifoam agents, bridging agents, and the like, or combinations thereof. These additives may be introduced singularly or in combination using any suitable methodology and in amounts effective to produce the desired improvements in fluid properties. As will be appreciated by one of skill in the art with the help of this disclosure, any of the components and/or additives used in the WSF have to be compatible with the wellbore servicing foam used in the WSF composition.

As will be appreciated by one of skill in the art with the help of this disclosure, any of the components and/or additives used in the WSF may be the same or different with the materials described previously herein as wellbore servicing materials to be included in the wellbore servicing foam. For example, a KCl salt may be added to both the wellbore servicing foam as a wellbore servicing material, and to the WSF as an optional additive.

In an embodiment, the WSF comprises a particulate material. In an embodiment, the particulate material comprises a proppant, a gravel, or combinations thereof. As used herein, a particulate material refers to a granular material that is suitable for use in a particulate pack (e.g., a proppant pack and/or a gravel pack). When deposited in a fracture, the particulate material may form a particulate pack (e.g., a proppant pack and/or a gravel pack) structure comprising conductive channels (e.g., flow channel spaces) through which fluids may flow to the wellbore. The particulate material functions to prevent the fractures from closing due to overburden pressures.

In an embodiment, the particulate material may be comprised of a naturally-occurring material. Alternatively, the particulate material comprises a synthetic material. Alternatively, the particulate material comprises a mixture of a naturally-occurring and synthetic material.

In an embodiment, the particulate material comprises a proppant, which may form a proppant pack when placed in the wellbore and/or subterranean formation. In an embodiment, the proppant may comprise any suitable granular material, which may be used to prop fractures open, i.e., a propping agent or a proppant.

Nonlimiting examples of proppants suitable for use in this disclosure include silica (sand), graded sand, Ottawa sands, Brady sands, Colorado sands; resin-coated sands; gravels; synthetic organic particles, nylon pellets, high density plastics, teflons, polytetrafluoroethylenes, rubbers, resins; ceramics, aluminosilicates; glass; sintered bauxite; quartz; aluminum pellets; ground or crushed shells of nuts, walnuts, pecans, almonds, ivory nuts, brazil nuts, and the like; ground or crushed seed shells (including fruit pits) of seeds of fruits, plums, peaches, cherries, apricots, and the like; ground or crushed seed shells of other plants (e.g., maize, corn cobs or corn kernels); crushed fruit pits or processed wood materials, materials derived from woods, oak, hickory, walnut, poplar, mahogany, and the like, including such woods that have been processed by grinding, chipping, or other form of particleization; resin coated materials; or combinations thereof. In an embodiment, the proppant comprises sand.

In an embodiment, the particulate material comprises a gravel, which may form a gravel pack when placed in the wellbore and/or subterranean formation. A “gravel pack” is a term commonly used to refer to a volume of particulate materials (such as gravel and/or sand) placed into a wellbore to at least partially reduce the migration of unconsolidated formation particulates into the wellbore. In an embodiment, the gravel pack comprises a proppant material of the type previously described herein.

The particulate materials may be of any suitable size and/or shape. In an embodiment, a particulate material suitable for use in the present disclosure may have an average particle size in the range of from about 2 to about 400 mesh, alternatively from about 8 to about 100 mesh, or alternatively from about 10 to about 70 mesh, U.S. Sieve Series.

In an embodiment, the particulate material may be included within the WSF in a suitable amount. In an embodiment, the particulate material may be present within the WSF in an amount of from about 0.1 pounds per gallon (ppg) to about 30 ppg, alternatively from about 0.5 ppg to about 28 ppg, or alternatively from about 10 ppg to about 15 ppg, based on the total volume of the WSF.

In an embodiment, the WSF further comprises a viscosifying agent or a viscosifier. Generally, when added to a fluid, a viscosifying agent increases the viscosity of such fluid. For example, a viscosifying agent may improve the ability of a WSF to suspend and transport a wellbore servicing foam and a particulate material to a desired location in a wellbore and/or subterranean formation. As another example, a viscosifying agent may improve the ability of a drilling fluid (e.g., an aqueous based drilling fluid comprising the wellbore servicing foam and a viscosifying agent to remove cuttings from a wellbore and to suspend cuttings and weighting agents during periods of non-circulation by increasing the viscosity of the drilling fluid.

In an embodiment, the viscosifying agent is comprised of a naturally-occurring material. Alternatively, the viscosifying agent comprises a synthetic material. Alternatively, the viscosifying agent comprises a mixture of a naturally-occurring and synthetic material.

In an embodiment, a viscosifying agent comprises viscosifying polymers, gelling agents, polyamide resins, polycarboxylic acids, fatty acids, soaps, clays, derivatives thereof, or combinations thereof. Examples of polymeric materials suitable for use as part of the viscosifying agent include, but are not limited to homopolymers, random, block, graft, star- and hyper-branched polyesters, copolymers thereof, derivatives thereof, or combinations thereof. The term “derivative” herein is defined to include any compound that is made from one or more of the viscosifying agents, for example, by replacing one atom in the viscosifying agent with another atom or group of atoms, rearranging two or more atoms in the viscosifying agent, ionizing one of the viscosifying agents, or creating a salt of one of the viscosifying agents.

In an embodiment, the viscosifying agent comprises a viscosifying polymer. In an embodiment, the viscosifying polymer may be used in uncrosslinked form. In an alternative embodiment, the viscosifying polymer may be a crosslinked polymer.

Nonlimiting examples of viscosifying polymers suitable for use in the present disclosure include polysaccharides, guar (e.g., guar gum), locust bean gum, Karaya gum, gum tragacanth, hydroxypropyl guar (HPG), carboxymethyl guar (CMG), carboxymethyl hydroxypropyl guar (CMHPG), hydrophobically modified guars, high-molecular weight polysaccharides composed of mannose and galactose sugars, heteropolysaccharides obtained by the fermentation of starch-derived sugars, xanthan gum, diutan, welan, gellan, scleroglucan, chitosan, dextran, substituted or unsubstituted galactomannans, starch, cellulose, cellulose ethers, carboxycelluloses, carboxymethyl cellulose (CMC), hydroxyethyl cellulose (HEC), hydroxypropyl cellulose, carboxyalkylhydroxyethyl celluloses, carboxymethyl hydroxyethyl cellulose (CMHEC), methyl cellulose, polyacrylic acid (PAC), sodium polyacrylate, polyacrylamide (PAM), partially hydrolyzed polyacrylamide (PHPA), polymethacrylamide, poly(acrylamido-2-methyl-propane sulfonate), polysodium-2-acrylamide-3-propylsulfonate, polyvinyl alcohol, copolymers of acrylamide and poly(acrylamido-2-methyl-propane sulfonate), terpolymers of poly(acrylamido-2-methyl-propane sulfonate), acrylamide and vinylpyrrolidone or itaconic acid, derivatives thereof, and the like, or combinations thereof.

In an embodiment, the viscosifying agent comprises a clay. Nonlimiting examples of clays suitable for use in the present disclosure include water swellable clays, bentonite, montmorillonite, attapulgite, kaolinite, metakaolin, laponite, hectorite, sepiolite, organophilic clays, amine-treated clays, and the like, or combinations thereof.

In an embodiment, the viscosifying agent comprises LGC-VI gelling agent, WG-31 gelling agent, WG-35 gelling agent, WG-36 gelling agent, GELTONE II viscosifier, TEMPERUS viscosifier, or combinations thereof. LGC-VI gelling agent is an oil suspension of a guar-based gelling agent specifically formulated for applications that require a super-concentrated slurry; WG-31, WG-35, and WG-36 gelling agents are guar-based gelling agents used as solids; GELTONE II viscosifier is an organophilic clay; and TEMPERUS viscosifier is a modified fatty acid; each of which is commercially available from Halliburton Energy Services.

In an embodiment, the viscosifying agents may be included within the WSF in a suitable amount. In an embodiment a viscosifying agent of the type disclosed herein may be present within the WSF in an amount of from about 0.01 wt. % to about 15 wt. %, alternatively from about 0.1 wt. % to about 10 wt. %, or alternatively from about 0.4 wt. % to about 5 wt. %, based on the total weight of the WSF.

In an embodiment, the WSF further comprises a crosslinker. In an embodiment, the WSF is an aqueous based fracturing fluid comprising the wellbore servicing foam, a viscosifying agent and a crosslinker. In another embodiment, the WSF is an aqueous based drilling fluid comprising the wellbore servicing foam, a viscosifying agent, and a crosslinker. Without wishing to be limited by theory, a crosslinker is a chemical compound or agent that enables or facilitates the formation of crosslinks, i.e., bonds that link polymeric chains to each other, with the end result of increasing the molecular weight of the polymer. When a fluid comprises a polymer (e.g., a viscosifying polymeric material), crosslinking such polymer generally leads to an increase in fluid viscosity (e.g., due to an increase in the molecular weight of the polymer), when compared to the same fluid comprising the same polymer in the same amount, but without being crosslinked. The presence of a crosslinker in a WSF comprising a viscosifying polymer may lead to a crosslinked fluid. For example, if the viscosity of the WSF comprising a viscosifying polymer is z, the viscosity of the crosslinked fluid may be at least about 2 z, alternatively about 10 z, alternatively about 20 z, alternatively about 50 z, or alternatively about 100 z. Crosslinked fluids are thought to have a three dimensional polymeric structure that is better able to support solids, such as for example wellbore servicing foams, particulate materials, proppants, gravels, drill cuttings, when compared to the same WSF comprising the same polymer in the same amount, but without being crosslinked.

Nonlimiting examples of crosslinkers suitable for use in the present disclosure include polyvalent metal ions, aluminum ions, zirconium ions, titanium ions, antimony ions, polyvalent metal ion complexes, aluminum complexes, zirconium complexes, titanium complexes, antimony complexes, and boron compounds, borate, borax, boric acid, calcium borate, magnesium borate, borate esters, polyborates, polymer bound boronic acid, polymer bound borates, and the like, or combinations thereof.

Examples of commercially available crosslinkers include without limitation BC-140 crosslinker; BC-200 crosslinker; CL-23 crosslinker; CL-24 crosslinker; CL-28M crosslinker; CL-29 crosslinker; CL-31 crosslinker; CL-36 crosslinker; K-38 crosslinker; or combinations thereof. BC-140 crosslinker is a specially formulated crosslinker/buffer system; BC-200 crosslinker is a delayed crosslinker that functions as both crosslinker and buffer; CL-23 crosslinker is a delayed crosslinking agent that is compatible with CO₂; CL-24 crosslinker is a zirconium-ion complex used as a delayed temperature-activated crosslinker; CL-28M crosslinker is a water-based suspension crosslinker of a borate mineral; CL-29 crosslinker is a fast acting zirconium complex; CL-31 crosslinker is a concentrated solution of non-delayed borate crosslinker; CL-36 crosslinker is a new mixed metal crosslinker; K-38 crosslinker is a borate crosslinker; all of which are available from Halliburton Energy Services.

In an embodiment, the crosslinker may be included within the WSF in a suitable amount. In an embodiment a crosslinker of the type disclosed herein may be present within the WSF in an amount of from about 10 parts per million (ppm) to about 500 ppm, alternatively from about 50 ppm to about 300 ppm, or alternatively from about 100 ppm to about 200 ppm, based on the total weight of the WSF.

In an embodiment, the WSF comprises a wellbore servicing foam, a particulate material and an aqueous base fluid. For example, the particulate material comprises sand; the aqueous base fluid comprises a KCl brine; and the wellbore servicing foam comprises a reducible material and a wellbore servicing material, wherein the wellbore servicing material is uniformly dispersed throughout the foam, and wherein the foam has (i) equal to or greater than 90% reticulated structure and (ii) a specific surface area of about 0.5 m²/g or greater as determined by pycnometry. In such embodiment, the reducible material comprises PLA and the wellbore servicing material comprises KCl.

In an embodiment, the WSF comprises a highly expanded, wellbore servicing foam, a particulate material and an aqueous base fluid. For example, the particulate material comprises sand; the aqueous base fluid comprises a KCl brine; and the highly expanded, wellbore servicing foam comprises a reducible material and a wellbore servicing material, wherein the wellbore servicing material is uniformly dispersed throughout the foam, wherein the foam has (i) a percentage expansion of about 1500% when compared to the same amount of the same reducible material in the absence of expansion, (ii) a specific surface area of about 0.5 m²/g or greater as determined by pycnometry, and (iii) equal to or greater than 90% reticulated structure. In such embodiment, the reducible material comprises PLA and the wellbore servicing material comprises KCl.

In an embodiment, the WSF comprises a reticulated, wellbore servicing foam, a particulate material and an aqueous base fluid. For example, the particulate material comprises sand; the aqueous base fluid comprises a KCl brine; and the reticulated, wellbore servicing foam comprises a reducible material and a wellbore servicing material, wherein the wellbore servicing material is uniformly dispersed throughout a reticulated structural matrix formed from the reducible material, wherein the reticulated foam material has (i) a predominately open-cell structure and (ii) a specific surface area of about 0.5 m²/g or greater as determined by pycnometry. In such embodiment, the reducible material comprises PGA and the wellbore servicing material comprises a breaker, such as for example sodium perborate.

In an embodiment, the WSF comprises a reticulated, highly expanded, wellbore servicing foam, a particulate material and an aqueous base fluid. For example, the particulate material comprises sand; the aqueous base fluid comprises a KCl brine; and the reticulated, highly expanded, wellbore servicing foam comprises a reducible material and a wellbore servicing material, wherein the wellbore servicing material is uniformly dispersed throughout a reticulated structural matrix formed from the reducible material, wherein the reticulated, highly expanded, wellbore servicing foam is characterized by (i) a percentage expansion of about 1500% when compared to the same amount of the same reducible material in the absence of expansion, and (ii) a specific surface area of about 0.5 m²/g as determined by pycnometry. In such embodiment, the reducible material comprises PGA and the wellbore servicing material comprises a breaker, such as for example sodium perborate.

In an embodiment, the WSF comprises a reticulated material, a particulate material and an aqueous base fluid. For example, the particulate material comprises sand; the aqueous base fluid comprises a KCl brine; and the reticulated material comprises a degradable polymer matrix and a weighting agent dispersed uniformly throughout the degradable polymer matrix, wherein the reticulated material has (i) an open-cell structure and (ii) a specific surface area of about 0.5 m²/g or greater as determined by pycnometry. In such embodiment, the degradable polymer matrix (e.g., degradable reducible material) comprises PLA and the weighting agent comprises KCl.

In an embodiment, the WSF comprises a reticulated, highly expanded material, a particulate material and an aqueous base fluid. For example, the particulate material comprises sand; the aqueous base fluid comprises a KCl brine; and the reticulated, highly expanded material comprises a degradable polymer matrix and, a weighting agent dispersed uniformly throughout the degradable polymer matrix, wherein the reticulated, highly expanded material may be characterized by (i) a percentage expansion of about 1500% when compared to the same amount of the same material in the absence of expansion, and (ii) a specific surface area of about 0.5 m²/g as determined by pycnometry. In such embodiment, the degradable polymer matrix (e.g., degradable reducible material) comprises PGA and the weighting agent comprises KCl.

In an embodiment, the WSF comprises a wellbore servicing foam, a viscosifying agent and an aqueous base fluid. For example, the viscosifying agent comprises guar gum; the aqueous base fluid comprises a KCl brine; and the wellbore servicing foam comprises a reducible material and a wellbore servicing material, wherein the wellbore servicing material is uniformly dispersed throughout the foam, and wherein the foam has (i) equal to or greater than 90% reticulated structure and (ii) a specific surface area of about 0.5 m²/g as determined by pycnometry. In such embodiment, the reducible material comprises PLA and the wellbore servicing material comprises a breaker, such as for example sodium perborate.

In an embodiment, the WSF comprises a highly expanded, wellbore servicing foam, a viscosifying agent and an aqueous base fluid. For example, the viscosifying agent comprises guar gum; the aqueous base fluid comprises a KCl brine; and the highly expanded, wellbore servicing foam comprises a reducible material and a wellbore servicing material, wherein the wellbore servicing material is uniformly dispersed throughout the foam, wherein the foam has (i) a percentage expansion of about 1500% when compared to the same amount of the same reducible material in the absence of expansion, (ii) a specific surface area of about 0.5 m²/g as determined by pycnometry, and (iii) equal to or greater than 90% reticulated structure. In such embodiment, the reducible material comprises PGA and the wellbore servicing material comprises a breaker, such as for example sodium perborate.

In an embodiment, the WSF composition comprising a wellbore servicing foam may be prepared using any suitable method or process. The components of the WSF (e.g., wellbore servicing foam, aqueous base fluid, viscosifying agent, particulate material, etc.) may be combined and mixed in by using any mixing device compatible with the composition, e.g., a mixer, a blender, etc.

A wellbore servicing foam of the type disclosed herein may be included in any suitable wellbore servicing fluid (WSF). As used herein, a “servicing fluid” or “treatment fluid” refers generally to any fluid that may be used in a subterranean application in conjunction with a desired function and/or for a desired purpose, including but not limited to fluids used to complete, work over, fracture, repair, or in any way prepare a wellbore for the recovery of materials residing in a subterranean formation penetrated by the wellbore. Examples of wellbore servicing fluids include, but are not limited to, fracturing fluids, gravel packing fluids, drilling fluids or muds, spacer fluids, lost circulation fluids, cement slurries, washing fluids, sweeping fluids, acidizing fluids, diverting fluids, consolidation fluids, or completion fluids. The servicing fluid is for use in a wellbore that penetrates a subterranean formation. It is to be understood that “subterranean formation” encompasses both areas below exposed earth and areas below earth covered by water such as ocean or fresh water.

In an embodiment, the components of the WSF are combined at the well site. In an embodiment, particulate materials may be added to the WSF on-the-fly (e.g., in real time or on-location) along with the other components/additives. The resulting WSF may be pumped downhole where it may function as intended (e.g., consolidate and/or enhance the conductivity of at least a portion of the wellbore and/or subterranean formation).

In an embodiment, the wellbore servicing foam may be assembled and prepared as a slurry in the form of a liquid additive. In an embodiment, the wellbore servicing foam and a wellbore servicing fluid may be blended until the wellbore servicing foam particulates are distributed throughout the fluid. By way of example, the wellbore servicing foam particulates and a wellbore servicing fluid may be blended using a blender, a mixer, a stirrer, a jet mixing system, or other suitable device. In an embodiment, a recirculation system keeps the wellbore servicing foam particulates uniformly distributed throughout the wellbore servicing fluid. In an embodiment, the wellbore servicing fluid comprises water, and may comprise at least one dispersant blended with the wellbore servicing foam particulates and the water to reduce the volume of water required to suspend the wellbore servicing foam particulates. An example of a suitable dispersant is FR-56 liquid friction reducer which is an oil-external emulsion or HYDROPAC service which is a water-based viscous gel system, each of which are commercially available from Halliburton Energy Services Inc. The concentration of the dispersant in the wellbore servicing fluid may be determined using any suitable methodology based on the desired slurry properties in accordance with conventional design techniques. In another alternative embodiment, the dispersant may already be present in the wellbore servicing fluid comprising water before the wellbore servicing fluid is blended with the wellbore servicing foam.

When it is desirable to prepare a WSF for use in a wellbore, a servicing fluid (e.g., a fracturing fluid) prepared at the wellsite or previously transported to and, if necessary, stored at the on-site location may be combined with the wellbore servicing foam and with additional water and optional other additives to form the WSF composition. In an embodiment, a particulate material (e.g., a proppant and/or a gravel) may be added to the fracturing fluid on-the-fly along with the other components/additives. The resulting WSF composition may be pumped downhole where it may function as intended, e.g., create at least one fracture in the subterranean formation, as will be described later herein.

In an embodiment, the wellbore servicing foam liquid additive is mixed with the additional water to form a diluted liquid additive, which is subsequently added to a WSF (e.g., a fracturing fluid). The additional water may comprise fresh water, salt water such as an unsaturated aqueous salt solution or a saturated aqueous salt solution, or combinations thereof. In an embodiment, the liquid additive comprising the wellbore servicing foam is injected into a delivery pump being used to supply the additional water to a WSF (e.g., a fracturing fluid) composition. As such, the water used to carry the wellbore servicing foam particulates and this additional water are both available to the WSF (e.g., a fracturing fluid) composition such that the wellbore servicing foam particulates may be dispersed throughout the WSF (e.g., fracturing fluid) composition.

In an alternative embodiment, the wellbore servicing foam prepared as a liquid additive is combined with a ready-to-use WSF (e.g., fracturing fluid) as the WSF (e.g., fracturing fluid) is being pumped into the wellbore. In such embodiments, the liquid additive may be injected into the suction of the pump. In such embodiments, the liquid additive can be added at a controlled rate to the water or the WSF (e.g., fracturing fluid) using a continuous metering system (CMS) unit. The CMS unit can also be employed to control the rate at which the additional water is introduced to the WSF (e.g., fracturing fluid) as well as the rate at which any other optional additives are introduced to the WSF (e.g., fracturing fluid) or the water. As such, the CMS unit can be used to achieve an accurate and precise ratio of water to wellbore servicing foam concentration in the WSF (e.g., fracturing fluid) such that the properties of the WSF (e.g., density, viscosity), are suitable for the downhole conditions of the wellbore. The concentrations of the components in the WSF (e.g., fracturing fluid), e.g., the wellbore servicing foam, can be adjusted to their desired amounts before delivering the composition into the wellbore. Those concentrations thus are not limited to the original design specification of the WSF (e.g., fracturing fluid) composition and can be varied to account for changes in the downhole conditions of the wellbore that may occur before the composition is actually pumped into the wellbore.

In an embodiment, the WSF is an aqueous based fracturing fluid comprising a wellbore servicing foam, a particulate material (e.g., a proppant), and an optional viscosifying agent. In another embodiment, the WSF is an aqueous based gravel packing fluid comprising a wellbore servicing foam, a particulate material (e.g., a gravel), and an optional viscosifying agent.

In an embodiment, the wellbore service being performed is a fracturing operation, such as for example hydraulic fracturing and/or frac-packing, wherein a WSF is placed (e.g., pumped downhole) in the formation. In such embodiment, the WSF is a fracturing fluid. As will be understood by one of ordinary skill in the art, the particular composition of a fracturing fluid will be dependent on the type of formation that is to be fractured. Fracturing fluids, in addition to a wellbore servicing foam, typically comprise an aqueous fluid (e.g., water), a surfactant, a proppant, acid, friction reducers, viscosifying agents, gelling agents, scale inhibitors, pH-adjusting agents, oxygen scavengers, iron-control agents, corrosion inhibitors, bactericides, and the like.

In an embodiment, the fracturing fluid comprises a particulate material comprising proppant of the type previously described herein. When deposited in a fracture, the proppant may form a proppant pack, resulting in conductive channels (e.g., flow channel spaces) through which fluids may flow to the wellbore. The proppant functions to prevent the fractures from closing due to overburden pressures. The proppant holds the fracture open while still allowing fluid flow through the permeability of the proppant particulate. The fracture, especially if propped open by a proppant pack, provides an additional flow path (e.g., conductive channels) for the oil or gas to reach the wellbore, which increases the rate of oil and/or gas production from the well, e.g., enhances the productivity of the wellbore. In an embodiment, the wellbore servicing foam may be added to the fracturing fluid and pumped downhole at the same time with the proppant.

In an embodiment, the wellbore servicing fluid comprises a composite treatment fluid. As used herein, the term “composite treatment fluid” generally refers to a treatment fluid comprising at least two component fluids. In such an embodiment, the two or more component fluids may be delivered into the wellbore separately via different flowpaths (e.g., such as via a flowbore, a wellbore tubular and/or via an annular space between the wellbore tubular and a wellbore wall/casing) and substantially intermingled or mixed within the wellbore (e.g., in situ) so as to form the composite treatment fluid. Composite treatment fluids are described in more detail in U.S. Patent Publication No. 20100044041 A1 which is incorporated herein in its entirety.

In an embodiment, the composite treatment fluid comprises a fracturing fluid (e.g., a composite fracturing fluid). In such an embodiment, the fracturing fluid may be formed from a first component and a second component. For example, in such an embodiment, the first component may comprise a proppant-laden slurry (e.g., a concentrated proppant-laden slurry pumped via a tubular flowbore) and the second component may comprise a fluid with which the proppant-laden slurry may be mixed to yield the composite fracturing fluid, that is, a diluent (e.g., an aqueous fluid, such as water pumped via an annulus).

In an embodiment, the proppant-laden slurry (e.g., the first component) comprises a base fluid, proppants, and a wellbore servicing foam of the type disclosed herein. In an embodiment, the base fluid may comprise an aqueous base fluid of the type previously described herein. In an alternative or additional embodiment, the base fluid may comprise an aqueous gel, a viscoelastic surfactant gel, an oil gel, a foamed gel, an emulsion, an inverse emulsion, or combinations thereof.

In an embodiment, the diluent (e.g., the second component) may comprise a suitable aqueous fluid, aqueous gel, viscoelastic surfactant gel, oil gel, a foamed gel, emulsion, inverse emulsion, or combinations thereof. For example, the diluent may comprise one or more of the compositions disclosed above with reference to the base fluid. In an embodiment, the diluent may have a composition substantially similar to that of the base fluid, alternatively, the diluent may have a composition different from that of the base fluid.

In an embodiment, the WSF comprising a wellbore servicing foam of the type disclosed herein, and the proppant are introduced into the wellbore in the same stream. In an alternative embodiment, components of the WSF are apportioned between separate flowpaths into the wellbore (e.g., split between an annular flowpath and a tubular flowpath formed by concentric wellbore tubulars). In such embodiment, the different fluids or streams that travel via different flowpaths may have densities and/or viscosities different from each other, such that each fluid may efficiently suspend and transport the particulates that it is intended to carry downhole. In such embodiment, the two different wellbore servicing fluid streams may come into contact and mix within the wellbore and/or subterranean formation proximate to a zone or interval to be treated (e.g., fractured). For example, a first wellbore servicing fluid stream may comprise a particulate material (e.g., a proppant), while a second wellbore servicing fluid stream may comprise a weelbore servicing foam, and the two different wellbore servicing fluid streams may come into contact and mix within the wellbore and/or subterranean formation proximate to a zone or interval to be treated (e.g., fractured).

In an embodiment, the wellbore service being performed is a gravel packing operation, wherein a WSF comprising a particulate material (e.g., gravel) is placed (e.g., pumped downhole) in the formation. In such embodiment, the WSF is a gravel packing fluid. Gravel packing operations commonly involve placing a gravel pack screen in the wellbore neighboring a desired portion of the subterranean formation, and packing the surrounding annulus between the screen and the subterranean formation with particulate materials that are sized to prevent and inhibit the passage of formation solids through the gravel pack with produced fluids. In some instances, a screenless gravel packing operation may be performed.

During well stimulation treatments, such as fracturing treatments and/or gravel packing treatments, the WSF (e.g., the fracturing fluid and/or gravel packing fluid) can suspend a particulate material (e.g., proppant, gravel, etc.) and deposit the particulate material in a desired location, such as for example a fracture, inter alia, to maintain the integrity of such fracture once the hydraulic pressure is released. After the particulate material is placed in the fracture and pumping stops, the fracture closes. The pores of the particulate material pack/bed and the surrounding formation are filled with the WSF (e.g., the fracturing fluid and/or gravel packing fluid) and should be cleaned out to maximize conductivity of the particulate material-filled space (e.g., a proppant-filled fracture, a gravel-filled fracture, or combinations thereof).

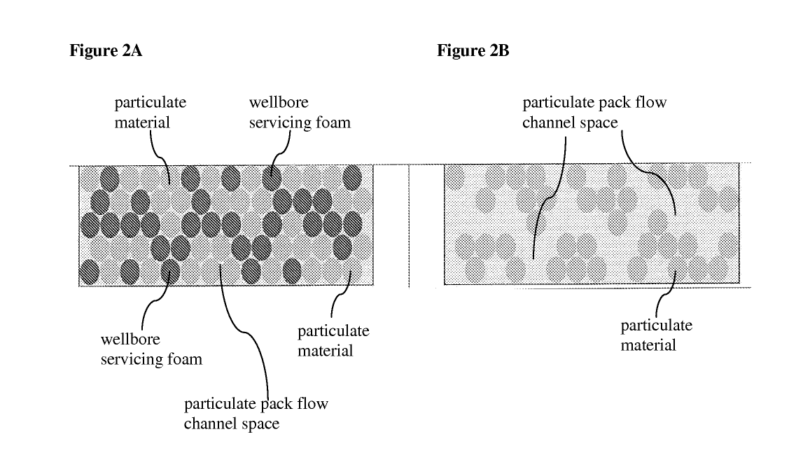

In an embodiment, the particulate material pack that is deposited in a fracture comprises a particulate material and a wellbore servicing foam, as seen in FIG. 2A. Once downhole, the wellbore servicing foam would degrade, and the space that was taken by the wellbore servicing foam as part of the particulate material pack may become part of the flowing space (e.g., flow channels) in the particulate material pack, as seen in FIG. 2B. In an embodiment, the use of wellbore servicing foam may increase the particulate material pack flow channel space by from about 10% to about 60%, alternatively from about 20% to about 50%, or alternatively from about 30% to about 40%, based on the flow space that would be created by the same amount of particulate material delivered in the fracture in the absence of a wellbore servicing foam.

In an embodiment, the wellbore servicing material of the wellbore servicing foam used in a particulate material pack may comprise a degradation accelerator, a breaker, or combinations thereof. In an embodiment, the degradation accelerator allows for the faster degradation of the reducible material of the wellbore servicing foam as previously described herein. In an embodiment, the degradation of the wellbore servicing foam (e.g., reducible material) may release a breaker which in turn would allow for a faster removal of the WSF (e.g., the fracturing fluid and/or gravel packing fluid), which is intended to be cleaned out to maximize conductivity of the particulate material-filled space (e.g., a proppant-filled fracture, a gravel-filled fracture, or combinations thereof).

In an embodiment, the use of a wellbore servicing foam in a wellbore servicing operation may allow for the delayed release of the wellbore servicing material of the wellbore servicing foam when compared to the use of a wellbore servicing material that is not part of a wellbore servicing foam. For example, the use of a wellbore servicing foam may allow for the release of the wellbore servicing material of the wellbore servicing foam that is delayed from about 1 hour to about 100 hours, alternatively equal to or greater than about 2 to about 3 hours, alternatively equal to or greater than about 24 hours, alternatively from equal to or greater than about 2 to about 5 days when compared to the use of a wellbore servicing material that is not part of a wellbore servicing foam. As noted previously, the extent of the delay which correlates with the rate of the degradation of the wellbore servicing foam (i.e., the faster the degradation rate, the lower the delay) may be adjusted by one of ordinary skill in the art with the benefit of this disclosure to meet the needs of the process by adjusting the properties of the wellbore servicing foam (e.g., specific surface area, type of reducible material, etc.). For example, a time delay in releasing a wellbore servicing material comprising a breaker may provide sufficient time for the WSF to suspend, transport and deposit the wellbore servicing foam in a particulate material pack in a wellbore and/or subterranean formation prior to the breaker reducing the viscosity of the WSF.

As it will be appreciated by one of ordinary skill in the art and with the help of this disclosure, a WSF comprising a wellbore servicing foam may be used for the formation and/or removal of filter cakes in any suitable stage of a wellbore's life, such as for example, during a drilling operation, completion operation, production stage, etc. In an embodiment, the WSF comprising a wellbore servicing foam may facilitate the formation of a filter cake on a surface of a wellbore and/or subterranean formation, wherein the filter cake comprises a wellbore servicing foam. In an embodiment, the wellbore servicing foam comprising a wellbore servicing material may lead to the delayed degradation of the filter cake, as will be described later herein.

In an embodiment, the WSF comprising a wellbore servicing foam of the type disclosed herein may be utilized in a drilling and completion operation. In such an embodiment, a WSF as disclosed herein is utilized as a drilling mud by being circulated through the wellbore while the wellbore is drilled in a conventional manner. As will be appreciated by one of skill in the art viewing this disclosure, as the WSF comprising a wellbore servicing foam is circulated through the wellbore, a portion of the WSF is deposited on the walls (e.g., the interior bore surface) of the wellbore, thereby forming a filter cake comprising a wellbore servicing foam. The solids contained in the WSF (e.g., drilling mud) may contribute to the formation of the filter cake about the periphery of the wellbore during the drilling of the well. Debris such as drilling mud and filter cakes left in the wellbore can have an adverse effect on several aspects of a well's completion and production stages, from inhibiting the performance of downhole tools to inducing formation damage and plugging production tubing. The presence of the filter cake may inhibit the loss of drilling mud (e.g., the WSF) or other fluids into the formation while also contributing to formation control and wellbore stability. Accordingly, concurrent with and/or subsequent to drilling operations where a filter cake is formed on a downhole surface, the filter cake or a portion thereof may need to be removed from the wellbore and/or the subterranean formation. In an embodiment, the filter cake comprises a wellbore servicing foam.

In an additional embodiment, the WSF comprising a wellbore servicing foam may be utilized in conjunction with a formation evaluation operation, such as for example electronically logging the wellbore. For example, in an embodiment, the wellbore may be evaluated via electronic logging techniques following sufficient contact time between the filter cake and the wellbore servicing material (e.g., a beaker) released by the wellbore servicing foam to remove all or a portion of the filter cake, as disclosed herein. In such an embodiment, a method of evaluating a formation utilizing a WSF of the type disclosed herein may generally comprise circulating a drilling fluid during a drilling operation and, upon the cessation of drilling operations and/or upon reaching a desired depth, removing the filter cake from a downhole surface (e.g., a wellbore surface, formation surface, etc.), as disclosed herein. Upon sufficient removal of the filter cake, logging tools may be run into the wellbore to a sufficient depth to characterize a desired portion of the subterranean formation penetrated by the wellbore.

In an embodiment, when desired (for example, upon the cessation of drilling operations and/or upon reaching a desired depth), the wellbore or a portion thereof may be prepared for completion. In completing the wellbore, it may be desirable to remove all or a substantial portion of the filter cake from the walls of the wellbore and/or the subterranean formation.

In an embodiment, the method of using a WSF comprising a wellbore servicing foam of the type disclosed herein may comprise completing the wellbore. In such an embodiment, the wellbore, or a portion thereof, may be completed by providing a casing string within the wellbore and cementing or otherwise securing the casing string within the wellbore. In such an embodiment, the casing string may be positioned (e.g., lowered into) the wellbore to a desired depth prior to, concurrent with, or following provision of the WSF wellbore servicing foam, and/or removal of the filter cake. When the filter cake has been sufficiently degraded and/or removed from the downhole surface (e.g., wellbore surface, formation surface, etc.), the WSF may be displaced from the wellbore by pumping a flushing fluid, a spacer fluid, and/or a suitable cementitious slurry downward through an interior flowbore of the casing string and into an annular space formed by the casing string and the wellbore walls. When the cementitious slurry has been positioned, the cementitious slurry may be allowed to set.

In an embodiment, removing the filter cake may comprise allowing the wellbore servicing foam to degrade and release the wellbore servicing material comprising a breaker, wherein the breaker may degrade at least a portion of the filter cake. The wellbore servicing foam may be configured to release wellbore servicing material comprising a breaker in situ (e.g., within the filter cake in a wellbore and/or subterranean formation) following the formation of the filter cake.

The use of a wellbore servicing foam comprising a wellbore servicing material (e.g., breaker) may exhibit a delayed filter cake removal when compared to a wellbore servicing material (e.g., breaker) that is not part of a wellbore servicing foam. For example, a wellbore servicing material comprising a breaker may exhibit filter cake removal that is delayed from about 1 hour to about 100 hours, alternatively equal to or greater than about 2 to about 3 hours, alternatively equal to or greater than about 24 hours, alternatively from equal to or greater than about 2 to about 5 days when compared to a wellbore servicing material that is not part of a wellbore servicing foam. As noted previously, the extent of the delay which correlates with the rate of the degradation of the wellbore servicing foam (i.e., the faster the degradation rate, the lower the delay) may be adjusted by one of ordinary skill in the art with the benefit of this disclosure to meet the needs of the process by adjusting the properties of the wellbore servicing foam (e.g., specific surface area, type of reducible material, etc.). The WSFs comprising a wellbore servicing foam of the type disclosed herein may result in the removal of filter cakes in a time delayed fashion so as to allow for the efficient removal of filter cake while minimizing damage to the formation or equipment or to allow for other servicing operations. For example, a time delay in removing the filter cake may provide sufficient time for the WSF to become fully and evenly distributed along a desired section of the wellbore. Such even treatment prevents isolated break-through zones in the filter cake (e.g., wormholing) that may undesirably divert subsequent servicing fluids placed downhole. Also, time delays in removing the filter cake may allow for subsequent servicing steps such as removing servicing tools from the wellbore. Following treatment with a WSF comprising a breaking agent and/or a breaking agent precursor, further servicing operations may be performed (e.g., completion and/or production operations) as desired or appropriate, as for example in a hydrocarbon-producing well.

In an embodiment, the WSF comprising a wellbore servicing foam and methods of using the same disclosed herein may be advantageously employed as a servicing fluid in the performance of one or more wellbore servicing operations. For example, when utilizing a WSF comprising a wellbore servicing foam of the type disclosed herein, the wellbore servicing foam may advantageously provide for the formation of larger particulate pack flow channels spaces in the fractures, which in turn may lead to an advantageously increased hydrocarbon production.

In an embodiment, the use of a WSF comprising a wellbore servicing foam may advantageously prove to be cost effective, as less reducible material is needed to form a particular volume of a foamed material than it would be needed for the same volume but lacking the foam structure.

In an embodiment, the use of a WSF comprising a wellbore servicing foam may advantageously provide for a faster degradation rate of the wellbore servicing foam, thereby avoiding an undesirable delay in wellbore servicing operations.

In an embodiment, the use of a WSF comprising a wellbore servicing foam may advantageously provide for the delayed release of a wellbore servicing material, such as for example to avoid the premature breaking of a viscosified fluid, to allow for the delayed breaking of a filter cake, etc. Additional advantages of the WSF system and/or the methods of using the same may be apparent to one of skill in the art viewing this disclosure.

### ADDITIONAL DISCLOSURE

A first embodiment, which is a wellbore servicing foam comprising a reducible material and a wellbore servicing material, wherein the wellbore servicing material is uniformly dispersed throughout the foam, and wherein the foam has (i) equal to or greater than 5% reticulated structure and (ii) a specific surface area of from about 0.1 m²/g to about 1000 m²/g as determined by pycnometry.

A second embodiment, which is a highly expanded, wellbore servicing foam comprising a reducible material and a wellbore servicing material, wherein the wellbore servicing material is uniformly dispersed throughout the foam, wherein the foam has (i) a percentage expansion of from about 5% to about 6200% when compared to the same amount of the same reducible material in the absence of expansion, (ii) a specific surface area of from about 0.1 m²/g to about 1000 m²/g as determined by pycnometry, and (iii) equal to or greater than 5% reticulated structure.

A third embodiment, which is the wellbore servicing foam of any of the first through the second embodiments having a pore size of from about 0.1 microns to about 3000 microns.

A fourth embodiment, which is the wellbore servicing foam of any of the first through the third embodiments having a porosity of from about 10 vol. % to about 99 vol. % based on the total volume of the wellbore servicing foam.

A fifth embodiment, which is the wellbore servicing foam of any of the first through the fourth embodiments having a particle size of from about 10 microns to about 12000 microns.

A sixth embodiment, which is the wellbore servicing foam of any of the first through the fifth embodiments having a degradation rate that is from about 100% per hour to about 100% per year greater than the degradation rate for the same amount of the same material in the absence of the reticulation.

A seventh embodiment, which is the wellbore servicing foam of any of the first through the sixth embodiments wherein the reducible material comprises a frangible material, an erodible material, a dissolvable material, a consumable material, a thermally degradable material, a meltable material, a boilable material, a degradable material, a biodegradable material, an ablatable material, or combinations thereof.

An eighth embodiment, which is the wellbore servicing foam of any of the first through the seventh embodiments wherein the reducible material comprises resins, epoxies, rubbers, hardened plastics, phenolic materials, polymeric materials, degradable polymers, composite materials, metallic materials, metals, metal alloys, cast materials, ceramic materials, ceramic based resins, composite materials, resin composite materials, or combinations thereof.

A ninth embodiment, which is the wellbore servicing foam of the seventh embodiment wherein the dissolvable material comprises an oil-soluble material, oil-soluble polymers, oil-soluble resins, oil-soluble elastomers, oil-soluble rubbers, latex, polyethylenes, polypropylenes, polystyrenes, carbonic acids, amines, waxes, copolymers thereof, derivatives thereof, or combinations thereof.

A tenth embodiment, which is the wellbore servicing foam of the eighth embodiment wherein the metallic materials comprise aluminum, magnesium, nickel, aluminum alloy, magnesium alloy, titanium alloy, nickel alloy, steel, titanium aluminide, nickel aluminide, or combinations thereof.

An eleventh embodiment, which is the wellbore servicing foam of the eighth embodiment wherein the resins comprise thermosetting resins, thermoplastic resins, solid polymer plastics, thermosetting epoxies, bismaleimides, cyanates, unsaturated polyesters, noncellular polyurethanes, orthophthalic polyesters, isophthalic polyesters, phthalic/maleic type polyesters, vinyl esters, phenolics, polyimides, nadic-end-capped polyimides, polyether ether ketones, polyaryletherketones, polysulfones, polyamides, polycarbonates, polyphenylene oxides, polysulfides, polyphenylenesulfide, polyether sulfones, polyamide-imides, polyetherimides, polyarylates, poly(lactide), poly(glycolide), liquid crystalline polyester, aromatic and aliphatic nylons, hardenable resins, organic resins, bisphenol A diglycidyl ether resins, butoxymethyl butyl glycidyl ether resins, bisphenol A-epichlorohydrin resins, bisphenol F resins, polyepoxide resins, novolak resins, polyester resins, phenol-aldehyde resins, urea-aldehyde resins, furan resins, urethane resins, glycidyl ether resins, epoxide resins, and any combinations thereof.

A twelfth embodiment, which is the wellbore servicing foam of the eighth embodiment wherein the degradable polymers comprise polysaccharides; lignosulfonates; chitins; chitosans; proteins; proteinous materials; fatty alcohols; fatty esters; fatty acid salts; orthoesters; aliphatic polyesters; poly(lactides); poly(glycolides); poly(c-caprolactones); polyoxymethylene; polyurethanes; poly(hydroxybutyrate); poly(anhydrides); aliphatic polycarbonates; polyvinyl polymers; acrylic-based polymers; poly(amino acids); poly(aspartic acid); poly(alkylene oxides); poly(ethylene oxides); polyphosphazenes; poly(orthoesters); poly(hydroxy ester ethers); polyether esters; polyester amides; polyamides; polyhdroxyalkanoates; polyethyleneterephthalates; polybutyleneterephthalates; polyethylenenaphthalenates; and copolymers, blends, derivatives, or combinations thereof.

A thirteenth embodiment, which is the wellbore servicing foam of the twelfth embodiment wherein the aliphatic polyester is represented by general formula I:

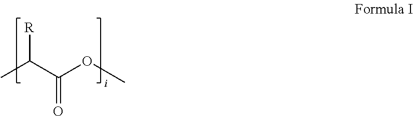

where i is an integer ranging from about 75 to about 10,000 and R comprises hydrogen, an alkyl group, an aryl group, alkylaryl groups, acetyl groups, heteroatoms, or combinations thereof.

A fourteenth embodiment, which is the wellbore servicing foam of any of the twelfth through the thirteen embodiments wherein the aliphatic polyester comprises polylactic acid, polyglycolic acid, or combinations thereof.

A fifteen embodiment, which is the wellbore servicing foam of any of the first through the fourteenth embodiments wherein the wellbore servicing material comprises a salt, a weighting agent, a degradation accelerator, a surfactant, a corrosion inhibitor, a scale inhibitor, a clay stabilizer, a defoamer, a resin, a proppant, a breaker, a fluid loss agent, or combinations thereof.

A sixteenth embodiment, which is the wellbore servicing foam of any of the first through the fifteenth wherein the wellbore servicing material is present in the wellbore servicing foam in an amount of from about 5 wt. % to about 95 wt. % based on the total weight of the wellbore servicing foam.

A seventeenth embodiment, which is a wellbore servicing fluid comprising (i) a wellbore servicing foam having equal to or greater than 5% reticulated structure and (ii) an aqueous base fluid.

An eighteenth embodiment, which is the wellbore servicing fluid of the seventeenth embodiment, wherein the wellbore servicing foam comprises a reducible material and a wellbore servicing material, wherein the wellbore servicing material is uniformly dispersed throughout the foam, and wherein the foam has a specific surface area of from about 0.1 m²/g to about 1000 m²/g as determined by pycnometry.

A nineteenth embodiment, which is the wellbore servicing fluid of any of the seventeenth through the eighteenth embodiments wherein the density of the wellbore servicing foam is about equal to the density of the wellbore servicing fluid.

A twentieth embodiment, which is the wellbore servicing fluid of any of the seventeenth through the nineteenth embodiments wherein the fluid is a fracturing fluid.

A twenty-first embodiment, which is the wellbore servicing fluid of any of the seventeenth through the nineteenth embodiments wherein the fluid is a gravel packing fluid.

A twenty-second embodiment, which is the wellbore servicing fluid of any of the seventeenth through the twenty-first embodiments further comprising a particulate material.

A twenty-third embodiment, which is the wellbore servicing fluid of the twenty-second embodiment wherein the particulate material is present in the wellbore servicing fluid in an amount of from about 0.1 ppg to about 30 ppg based on the total volume of the wellbore servicing fluid.

A twenty-fourth embodiment, which is the wellbore servicing fluid of any of the twenty-second through the twenty-third embodiments wherein the wellbore servicing foam is present in the wellbore servicing fluid in an amount of from about 0.01 wt. % to about 100 wt. % based on the total weight of the particulate material.

A twenty-fifth embodiment, which is the wellbore servicing fluid of any of the twenty-second through the twenty-fourth embodiments, wherein the particulate material comprises a proppant, a gravel, or combinations thereof.

A twenty-sixth embodiment, which is the wellbore servicing fluid of any of the seventeenth through the twenty-fifth embodiments further comprising a viscosifying agent.

A twenty-seventh embodiment, which is a method of servicing a wellbore in a subterranean formation comprising:
preparing a wellbore servicing fluid comprising a wellbore servicing foam having equal to or greater than 5% reticulated structure, a particulate material and an aqueous base fluid;
placing the wellbore servicing fluid in the wellbore and/or subterranean formation; and
allowing the reticulated material to degrade therein, wherein the degradation of the reticulated material yields a particulate material pack structure comprising a particulate material pack flow channel space.

A twenty-eighth embodiment, which is the method of the twenty-seventh embodiment wherein the wellbore servicing foam comprises a reducible material and a wellbore servicing material, wherein the wellbore servicing material is uniformly dispersed throughout the foam, and wherein the foam has a specific surface area of from about 0.1 m²/g to about 1000 m²/g as determined by pycnometry.

A twenty-ninth embodiment, which is the method of the twenty-eighth embodiment wherein the reducible material comprises polylactic acid and the wellbore servicing material comprises a breaker.

A thirtieth embodiment, which is the method of any of the twenty-seventh through the twenty-ninth embodiments wherein the particulate material pack flow channel space is from about 10% to about 60% greater than the particulate material pack flow channel space that would be created by the same amount of particulate material in the absence of the wellbore servicing foam.

A thirty-first embodiment, which is a method of servicing a wellbore in a subterranean formation comprising:
preparing a wellbore servicing fluid comprising a wellbore servicing foam having equal to or greater than 5% reticulated structure, and an aqueous base fluid, wherein the wellbore servicing foam comprises a breaker dispersed uniformly throughout the foam;
placing the wellbore servicing fluid in the wellbore and/or subterranean formation and forming a filter cake on a surface of the wellbore and/or subterranean formation, wherein the filter cake comprises the wellbore servicing foam;
allowing the wellbore servicing foam to degrade, wherein the degradation of the wellbore servicing foam provides for release of the breaker; and
allowing the breaker to degrade the filter cake.

A thirty-second embodiment, which is the method of the thirty-first embodiment wherein the wellbore servicing foam comprises reducible material and a wellbore servicing material, wherein the wellbore servicing material is uniformly dispersed throughout the foam, and wherein the foam has a specific surface area of from about 0.1 m²/g to about 1000 m²/g as determined by pycnometry.

A thirty-third embodiment, which is the method of any of the thirty-first through the thirty-second embodiments wherein the wellbore servicing fluid is a drilling fluid.

A thirty-fourth embodiment, which is a process for preparing a wellbore servicing foam comprising:
introducing a reducible material, a wellbore servicing material, and a foaming agent to an extruder;
heating the reducible material and the wellbore servicing material to form a melt mixture, wherein the foaming agent introduces porosity into the melt mixture; and
extruding the melt mixture through a die assembly to form the wellbore servicing foam.

A thirty-fifth embodiment, which is the process of the thirty-fourth embodiment wherein the foaming agent comprises a physical blowing agent, a chemical foaming agent, or combinations thereof.

A thirty-sixth embodiment, which is the process of the thirty-fourth embodiment wherein the physical blowing agent comprises air, carbon dioxide, nitrogen, pressurized liquids, water vapor, steam, propane, n-butane, isobutane, pentane, n-pentane, 2,3-dimethylpropane, 1-pentene, cyclopentene, n-hexane, 2-methylpentane, 3-methylpentane, 2,3-dimethylbutane, 1-hexene, cyclohexane, n-heptane, 2-methylhexane, 2,2-dimethylpentane, 2,3-dimethylpentane, and combinations thereof.

A thirty-seventh embodiment, which is the process of the thirty-fourth embodiment wherein the chemical foaming agent comprises carbonic acids, carboxylic acids, polycarboxylic acids, salts thereof, or combinations thereof.

A thirty-eighth embodiment, which is the process of any of the thirty-fourth through the thirty-seventh embodiments wherein the extruder comprises a single-screw extruder or a twin-screw extruder.

A thirty-ninth embodiment, which is the process of the thirty-eighth embodiment wherein the twin-screw extruder comprises a counter-rotating intermeshing twin-screw extruder, a counter-rotating non-intermeshing twin-screw extruder, a co-rotating intermeshing twin-screw extruder, or a co-rotating non-intermeshing twin-screw extruder.

A fortieth embodiment, which is the process of any of the thirty-fourth through the thirty-ninth embodiments wherein heating the reducible material and the wellbore servicing material comprises using heat generated by an electrical source surrounding an extruder barrel; heat generated by hot liquid jackets surrounding the extruder barrel; heat generated by steam jackets surrounding the extruder barrel; heat generated by steam injection at various ports along the extruder barrel; heat generated by viscous dissipation or friction; or combinations thereof.

A forty-first embodiment, which is the process of any of the thirty-fourth through the fortieth embodiments wherein the reducible material and the wellbore servicing material are heated to a temperature of from about 120° F. to about 400° F.

A forty-second embodiment, which is the process of any of the thirty-fourth through the forty-first embodiments wherein the wellbore servicing foam comprises a porosity of from about 10 vol. % to about 99 vol. % based on the total volume of the wellbore servicing foam.

A forty-third embodiment, which is the process of the forty-second embodiment wherein the porosity of the wellbore servicing foam is controlled according to Equation 3:

$${P}_{swell} = \frac{{A}_{0} {{Γ}^{m - 2} ( \frac{Δ {P}_{die}}{{( L / D )}_{die}} )}^{2}}{{Γ}^{2 n - 2} {e}^{- Δ E ( 1 / {T}_{ref} - 1 / T ) / R}} \qquad ( 3 )$$

wherein P_{swell} is a die pressure at an exit of a die hole; A₀ is a rheological material constant determined by stress/strain measurements; Γ is a shear rate on an inside wall of a die; m is a material constant obtained by measuring normal stress differences in a normal force rheometer; ΔP_{die} is a differential pressure across the die; (L/D)_{die} is a ratio of length to diameter of a single die hole; n is a power law shear thinning index measured by conventional shear stress shear rate rheometry; ΔE is an activation energy; T_{ref} is a temperature at which rheology measurements are made; T is a temperature of an extrudate material exiting the die; and R is universal gas constant.

A forty-fourth embodiment, which is the process of any of the thirty-fourth through the forty-third embodiments wherein the die assembly comprises a die hole with a diameter of from about 2 microns to about 2000 microns.

A forty-fifth embodiment, which is a process for preparing a wellbore servicing foam comprising:
introducing a reducible material to a twin-screw co-rotating intermeshing extruder, wherein co-rotating intermeshing screws convey the reducible material;
heating the reducible material to form a melt mixture, wherein heat is generated by frictional dissipation or via direct convection/conduction heat being transferred from barrel jackets of the extruder;
blending a wellbore servicing material in the melt mixture;
introducing a foaming agent to the melt mixture, wherein the foaming agent introduces porosity into the melt mixture and wherein the foaming agent comprises carbon dioxide or nitrogen;
extruding the melt mixture through a die assembly to form an extrudate wellbore servicing foam, wherein the die assembly comprises a die hole with a diameter of from about 2 microns to about 2000 microns and wherein the environment surrounding the die assembly is kept pressurized by water vapor;
cutting the extrudate wellbore servicing foam into lengths that are from about 0.25 to about 5 times the diameter of the die hole;
cooling the extrudate wellbore servicing foam;
drying the extrudate wellbore servicing foam; and
mechanically sizing the extrudate wellbore servicing foam into a plurality of wellbore servicing foam particles, wherein mechanically sizing comprises grinding.

A forty-sixth embodiment, which is the process of the forty-fifth embodiment wherein the porosity of the wellbore servicing foam is controlled by a Maxwellian die swell process control model according to Equation 3:

$${P}_{swell} = \frac{{A}_{0} {{Γ}^{m - 2} ( \frac{Δ {P}_{die}}{{( L / D )}_{die}} )}^{2}}{{Γ}^{2 n - 2} {e}^{- Δ E ( 1 / {T}_{ref} - 1 / T ) / R}} \qquad ( 3 )$$

wherein P_{swell} is a die pressure at an exit of the die hole; A₀ is a rheological material constant determined by stress/strain measurements; Γ is a shear rate on an inside wall of a die; m is a material constant obtained by measuring normal stress differences in a normal force rheometer; ΔP_{die} is a differential pressure across the die; (L/D)_{die} is a ratio of length to diameter of a single die hole; n is a power law shear thinning index measured by conventional shear stress shear rate rheometry; ΔE is an activation energy; T_{ref} is a temperature at which rheology measurements are made; T is a temperature of an extrudate material exiting the die; and R is universal gas constant.

A forty-seventh embodiment, which is a process for preparing a wellbore servicing foam comprising:
introducing a reducible material to a twin-screw co-rotating intermeshing extruder, wherein co-rotating intermeshing screws convey the reducible material;
heating the reducible material to form a melt mixture, wherein the heat is generated by frictional dissipation or via direct convection/conduction heat being transferred from barrel jackets of the extruder;
blending a breaker and a wellbore servicing material in the melt mixture;
introducing a foaming agent to the melt mixture, wherein the foaming agent introduces porosity into the melt mixture and wherein the foaming agent comprises carbon dioxide or nitrogen;
extruding the melt mixture through a die assembly and into a pelleting mill to form an extrudate wellbore servicing foam, wherein the melt mixture is physically forced into the die assembly by a planetary system of rotating press wheels, wherein the die assembly comprises a die hole with a diameter of from about 2 microns to about 2000 microns and wherein the environment surrounding the die assembly is kept pressurized by water vapor;
cooling the extrudate wellbore servicing foam;
drying the extrudate wellbore servicing foam; and
mechanically sizing the extrudate wellbore servicing foam into a plurality of wellbore servicing foam particles, wherein mechanically sizing comprises grinding.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A wellbore servicing foam comprising a reducible material and a wellbore servicing material, wherein the wellbore servicing material is uniformly dispersed throughout the foam, and wherein the foam has (i) equal to or greater than 5% reticulated structure and (ii) a specific surface area of from about 0.1 m²/g to about 1000 m²/g as determined by pycnometry.

2. (canceled)

3. The wellbore servicing foam of claim 1 having a pore size of from about 0.1 microns to about 3000 microns.

4. The wellbore servicing foam of claim 1 having a porosity of from about 10 vol. % to about 99 vol. % based on the total volume of the wellbore servicing foam.

5. The wellbore servicing foam of claim 1 having a particle size of from about 10 microns to about 12000 microns.

6. The wellbore servicing foam of claim 1 having a degradation rate that is from about 100% per hour to about 100% per year greater than the degradation rate for the same amount of the same material in the absence of the reticulation.

7. The wellbore servicing foam of claim 1 wherein the reducible material comprises a frangible material, an erodible material, a dissolvable material, a consumable material, a thermally degradable material, a meltable material, a boilable material, a degradable material, a biodegradable material, an ablatable material, or combinations thereof.

8. The wellbore servicing foam of claim 1 wherein the reducible material comprises resins, epoxies, rubbers, hardened plastics, phenolic materials, polymeric materials, degradable polymers, composite materials, metallic materials, metals, metal alloys, cast materials, ceramic materials, ceramic based resins, composite materials, resin composite materials, or combinations thereof.

9.-13. (canceled)

14. The wellbore servicing foam of claim 8 wherein the degradable polymer comprises at least one aliphatic polyester selected from the group consisting of: polylactic acid, polyglycolic acid, and any combination thereof.

15. (canceled)

16. The wellbore servicing foam of claim 1 wherein the wellbore servicing material is present in the wellbore servicing foam in an amount of from about 5 wt. % to about 95 wt. % based on the total weight of the wellbore servicing foam.

17. A wellbore servicing fluid comprising (i) a wellbore servicing foam having equal to or greater than 5% reticulated structure and (ii) an aqueous base fluid.

18. The wellbore servicing fluid of claim 17, wherein the wellbore servicing foam comprises a reducible material and a wellbore servicing material, wherein the wellbore servicing material is uniformly dispersed throughout the foam, and wherein the foam has a specific surface area of from about 0.1 m²/g to about 1000 m²/g as determined by pycnometry.

19. The wellbore servicing fluid of claim 17 wherein the density of the wellbore servicing foam is about equal to the density of the wellbore servicing fluid.

20.-21. (canceled)

22. The wellbore servicing fluid of claim 17 further comprising a particulate material.

23. The wellbore servicing fluid of claim 22 wherein the particulate material is present in the wellbore servicing fluid in an amount of from about 0.1 ppg to about 30 ppg based on the total volume of the wellbore servicing fluid.

24. The wellbore servicing fluid of claim 22 wherein the wellbore servicing foam is present in the wellbore servicing fluid in an amount of from about 0.01 wt. % to about 100 wt. % based on the total weight of the particulate material.

25. (canceled)

26. The wellbore servicing fluid of claim 17 further comprising a viscosifying agent.

27. A method of servicing a wellbore in a subterranean formation comprising:
preparing a wellbore servicing fluid comprising a wellbore servicing foam having equal to or greater than 5% reticulated structure, a particulate material and an aqueous base fluid;
placing the wellbore servicing fluid in the wellbore and/or subterranean formation; and
allowing the reticulated material to degrade therein, wherein the degradation of the reticulated material yields a particulate material pack structure comprising a particulate material pack flow channel space.

28. The method of claim 27 wherein the wellbore servicing foam comprises a reducible material and a wellbore servicing material, wherein the wellbore servicing material is uniformly dispersed throughout the foam, and wherein the foam has a specific surface area of from about 0.1 m²/g to about 1000 m²/g as determined by pycnometry.

29. The method of claim 28 wherein the reducible material comprises polylactic acid and the wellbore servicing material comprises a breaker.

30. The method of claim 27 wherein the particulate material pack flow channel space is from about 10% to about 60% greater than the particulate material pack flow channel space that would be created by the same amount of particulate material in the absence of the wellbore servicing foam.

31.-47. (canceled)
